(19) United States
(12) Patent Application Publication
(10) Pub. No.: US 2025/0272319 A1
(43) Pub. Date: Aug. 28, 2025

(54) INFORMATION PROCESSING APPARATUS, INFORMATION PROCESSING SYSTEM, INFORMATION PROCESSING METHOD, AND RECORDING MEDIUM

(71) Applicant: Naoyuki SHIMIZU, Kanagawa (JP)

(72) Inventor: Naoyuki SHIMIZU, Kanagawa (JP)

(21) Appl. No.: 19/050,201

(22) Filed: Feb. 11, 2025

(30) Foreign Application Priority Data
Feb. 22, 2024 (JP) 2024-025976
Nov. 8, 2024 (JP) 2024-196058

(51) Int. Cl. G06F 16/3329

(52) U.S. Cl. CPC G06F 16/33295

(57) ABSTRACT

An information processing apparatus includes circuitry that receives an input of question data, outputs to a large-scale language model a prompt requesting generation of answer data to the question data based on user-specific information, and outputs to a terminal apparatus output answer data that is output from the large-scale language model in response to an input of the prompt.

### CROSS-REFERENCE TO RELATED APPLICATIONS

This patent application is based on and claims priority pursuant to 35 U.S.C. § 119 (a) to Japanese Patent Application Nos. 2024-025976, filed on Feb. 22, 2024, and 2024-196058, filed on Nov. 8, 2024, in the Japan Patent Office, the entire disclosure of each is hereby incorporated by reference herein.

### BACKGROUND

### Technical Field

The present disclosure relates to an information processing apparatus, an information processing system, an information processing method, and a recording medium.

### Related Art

The recent large-scale language model learns a large amount of data using a model having more than ten times as many parameters as the general language model. In this large-scale language model, when a prompt including a small amount of example data is input, the pre-learned model interprets a pattern in the prompt, and generates and outputs a word or a sentence corresponding to the input. The prompt is an example of text data for expressing an instruction or a question for the large-scale language model.

The large-scale language model described above performs learning based on information that is generally disclosed on the Internet. Therefore, it is difficult to present an answer based on information that is not generally available, such as information unique to a user who uses the large-scale language model.

### SUMMARY

Example embodiments include an information processing apparatus including circuitry that receives an input of question data, outputs to a large-scale language model a prompt requesting generation of answer data to the question data based on user-specific information, and outputs to a terminal apparatus output answer data that is output from the large-scale language model in response to an input of the prompt.

Example embodiments include an information processing system including the information processing apparatus, and the terminal apparatus including a display that displays the question data and the output answer data in association.

Example embodiments include an information processing method including: receiving an input of question data; in response to receiving the input of the question data, outputting, to a large-scale language model, a prompt requesting generation of answer data to the question data based on user-specific information; and outputting answer data that is output from the large-scale language model in response to an input of the prompt for display, the question data and the output answer data being displayed in association.

Example embodiments include a non-transitory recording medium which, when executed by one or more processors, causes the processors to perform an information processing method including: receiving an input of question data; in response to receiving the input of the question data, outputting, to a large-scale language model, a prompt requesting generation of answer data to the question data based on user-specific information; and outputting, to a terminal apparatus, output answer data that is output from the large-scale language model in response to an input of the prompt.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a chat system;

FIG. 2 is a diagram illustrating an example hardware configuration of an information processing apparatus;

FIG. 3 is a diagram illustrating a hardware configuration of a terminal apparatus;

FIG. 4 is a table illustrating an example conversation history database (DB);

FIG. 5 is a table illustrating an example question and answer DB;

FIG. 6 is a table illustrating an example document DB;

FIG. 7 is a table illustrating an example user information DB;

FIG. 8 is a diagram illustrating functional configurations of apparatuses or devices included in the chat system of FIG. 1;

FIG. 9 is a sequence diagram illustrating an example operation performed by the chat system of FIG. 8;

FIG. 10 is a diagram illustrating an example prompt;

FIG. 11 is a diagram illustrating an example prompt;

FIG. 12 is a first diagram illustrating an example screen displayed by the terminal apparatus of FIG. 9;

FIG. 13 is a second diagram illustrating an example screen displayed by the terminal apparatus of FIG. 9;

FIG. 14 is a third diagram illustrating an example screen displayed by the terminal apparatus of FIG. 9;

FIG. 15 is a fourth diagram illustrating an example screen displayed by the terminal apparatus of FIG. 9;

FIG. 16 is a sequence diagram illustrating an example operation performed by the chat system of FIG. 8;

FIG. 17 is a diagram illustrating an example prompt;

FIG. 18 is a sequence diagram illustrating an example operation performed by the chat system of FIG. 8;

FIG. 19 is a diagram illustrating an example screen displayed by the terminal apparatus of FIG. 18;

FIG. 20 is a sequence diagram illustrating an example operation performed by the chat system of FIG. 8;

FIG. 21 is a diagram illustrating an example screen displayed by the terminal apparatus of FIG. 20;

FIG. 22 is a diagram illustrating an example prompt;

FIG. 23 is a sequence diagram illustrating an example operation performed by the chat system of FIG. 8;

FIG. 24 is a first diagram illustrating an example screen displayed by the terminal apparatus of FIG. 23;

FIG. 25 is a second diagram illustrating an example screen displayed by the terminal apparatus of FIG. 23;

FIG. 26 is a third diagram illustrating an example screen displayed by the terminal apparatus of FIG. 23;

FIG. 27 is a sequence diagram illustrating an example operation performed by the chat system of FIG. 8;

FIG. 28 is a diagram illustrating an example prompt;

FIG. 29 is a diagram illustrating an example prompt;

FIG. 30 is a diagram illustrating an example prompt;

FIG. 31 is a diagram illustrating functional configurations of apparatuses or devices included in the chat system of FIG. 1;

FIG. 32 is a table illustrating an example document DB;

FIG. 33 is a table illustrating an example chunk DB;

FIG. 34 is a table illustrating an example scenario DB;

FIG. 35 is a first sequence diagram illustrating an example operation performed by the chat system of FIG. 31;

FIG. 36 is a second sequence diagram illustrating an example operation performed by the chat system of FIG. 31;

FIG. 37 is a first diagram illustrating an example screen displayed by the terminal apparatus of FIG. 31;

FIG. 38 is a second diagram illustrating an example screen displayed by the terminal apparatus of FIG. 31;

FIG. 39 is a third diagram illustrating an example screen displayed by the terminal apparatus of FIG. 31;

FIG. 40 is a third sequence diagram illustrating an example operation performed by the chat system of FIG. 31; and

FIG. 41 is a fourth diagram illustrating an example screen displayed by the terminal apparatus of FIG. 40.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

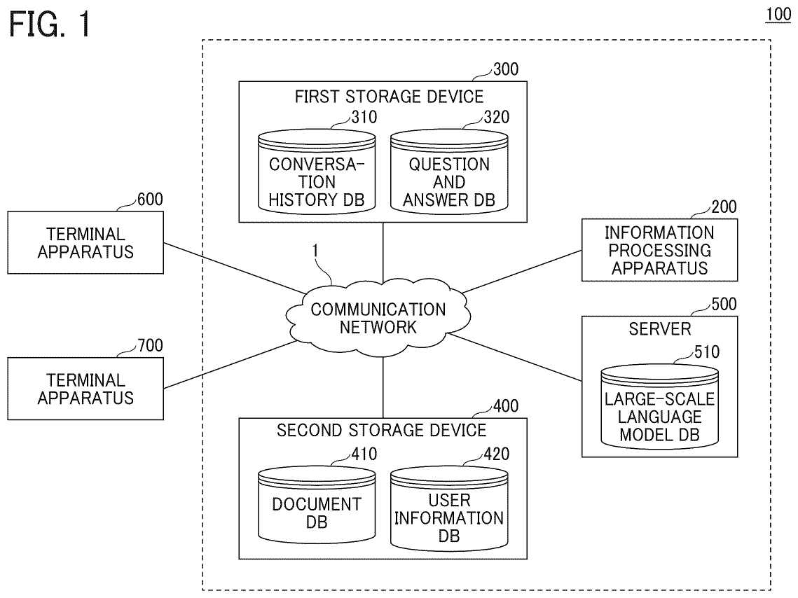

FIG. 1 is a diagram illustrating an example configuration of a chat system 100. The chat system 100, which is an example of an information processing system, includes an information processing apparatus 200, a first storage device 300, a second storage device 400, a server 500, a terminal apparatus 600, and a terminal apparatus 700, which are connected to each other via a communication network 1.

In the chat system 100, the information processing apparatus 200, the first storage device 300, the second storage device 400, and the server 500 operate in cooperation to provide a chatbot service to a user of the terminal apparatus 600.

When a question is input at the terminal apparatus 600, the information processing apparatus 200 outputs to the terminal apparatus 600 an answer to the question that is input.

The first storage device 300 includes a conversation history database (DB) 310 and a question and answer DB 320. The conversation history DB 310, which is an example of a conversation storage history unit, stores conversation history information in which questions input from the terminal apparatus 600 are associated with answers output to the terminal apparatus 600. The conversation history information may be managed by each tenant that uses the chat system 100. The tenant may be an organization to which a user who uses the chat system 100 belongs, such as a company that the user works for.

The question and answer DB 320, which is an example of a question and answer storage unit, stores question and answer information in which questions and answers are associated with each other. The question and answer DB 320 is an example of sets of question and answer information in which question data indicating a question and answer data indicating an answer are associated with each other. The question and answer information, which are previously stored in the question and answer DB 320, may be managed by each tenant that uses the chat system 100.

The second storage device 400 includes a document DB 410 and a user information DB 420. The document DB 410, which is an example of a document storage unit, stores user-specific information specific to the user, such as private information that is not open to the public.

The user of the chat system 100 may be, for example, the tenant. In the case where the user is the tenant, the user-specific information is information specific to the tenant. Alternatively, the user of the chat system 100 may be an individual user. In the case where the user is the individual user, the user-specific information is information specific to the individual user.

In the following description, in-company information is used as an example of the user-specific information.

The document DB 410 may store the in-company information by each tenant. The user information DB 420 stores, for each tenant, user information regarding one or more users belonging to the tenant.

The server 500 includes a large-scale language model DB 510, and operates as generative artificial intelligence (AI). The generative AI generates text corresponding to a prompt being input, and outputs the generated text to the information processing apparatus 200. Chat Generative Pretrained Transformer (GPT) is one example of the generative AI. The prompt is text data that describes an instruction or a question to the server 500 operating as the generative AI. The large-scale language model will be described in detail below.

The terminal apparatus 600 is operated, for example, by the user who uses the chat system 100. The terminal apparatus 700 is operated, for example, by an administrator who manages the chat system 100. The terminal apparatus 600 and the terminal apparatus 700 may be, for example, a smartphone or a tablet terminal.

In the chat system 100, in response to receiving input of a question by the user, the terminal apparatus 600 transmits question data indicating the question to the information processing apparatus 200.

In response to receiving the question data from the terminal apparatus 600, the information processing apparatus 200 acquires, from the conversation history DB 310 of the first storage device 300, conversation history information for a certain period of time before the question is input to the terminal apparatus 600. The information processing apparatus 200 outputs, to the server 500, a prompt that requests generation of a query (search key) for searching the document DB 410 of the second storage device 400, using the input question and the acquired conversation history information.

The server 500 inputs the prompt requesting generation of the query to the large-scale language model stored in the large-scale language model DB 510, and transmits output data output from the large-scale language model to the information processing apparatus 200. The information processing apparatus 200 searches the document DB 410 of the second storage device 400 using the output data received from the server 500 as a query, and acquires the in-company information as a search result.

The information processing apparatus 200 outputs, to the server 500, a prompt that requests generation of an answer to the question input from the terminal apparatus 600, using the in-company information acquired as the search result as an information source.

The server 500 inputs a prompt that requests generation of an answer to the large-scale language model stored in the large-scale language model DB 510, and transmits output data output from the large-scale language model to the information processing apparatus 200. The information processing apparatus 200 transmits the output data received from the server 500 to the terminal apparatus 600 as answer data.

The terminal apparatus 600 displays the answer data received from the information processing device 200 as an answer to the input question.

Through the above-described operation, an answer to a question is generated by the large-scale language model based on information specific to the user that is not publicly available. The chat system 100 thus provides a response based on the user-specific information.

As the information source for generating the answer to the question, the chat system 100 uses the in-company information, which is obtained as a result of searching the document DB 410 based on the conversation history information collected before the question is input. Further, an amount of the in-company information to be referred to as the information source is controlled, before the in-company information is transmitted to the server 500. Accordingly, the accuracy in answer is improved, while controlling the number of inputs to fit within the token limits of the large-scale language model.

In the example of FIG. 1, the information processing apparatus 200, the first storage device 300, and the second storage device 400 are illustrated as separate devices, but any one of these apparatuses or devices may be combined into one apparatus or device. For example, the first storage device 300 and the second storage device 400 may be included in the information processing apparatus 200.

In FIG. 1, the information processing apparatus 200 may be implemented by one or more information processing apparatuses, such that a plurality of information processing apparatuses 200 may be illustrated.

Alternatively, the chat system 100 may only include the information processing apparatus 200 and the terminal apparatus 600, such that any other apparatus may not be included in the chat system 100.

An example hardware configuration of each apparatus or device included in the chat system 100 is described below.

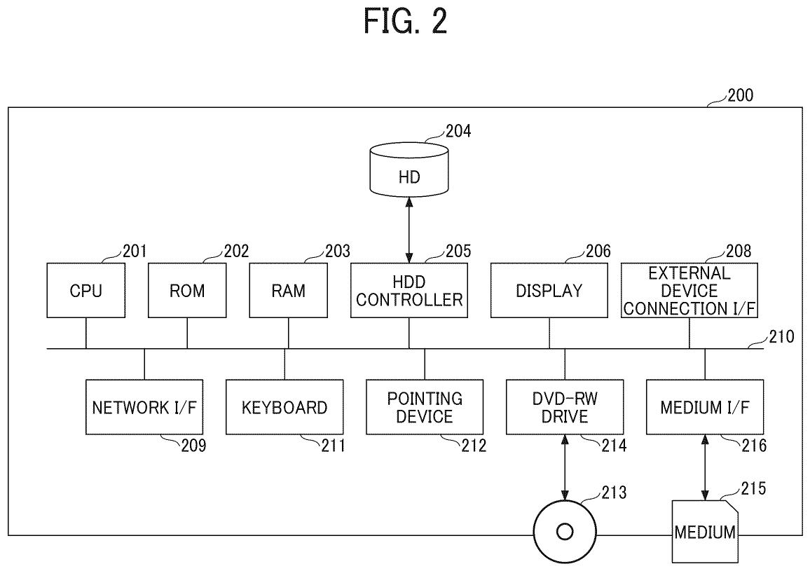

The information processing apparatus 200, the first storage device 300, the second storage device 400, and the server 500 are each implemented by the general-purpose computer. An example hardware configuration of the information processing apparatus 200 is described below with reference to FIG. 2.

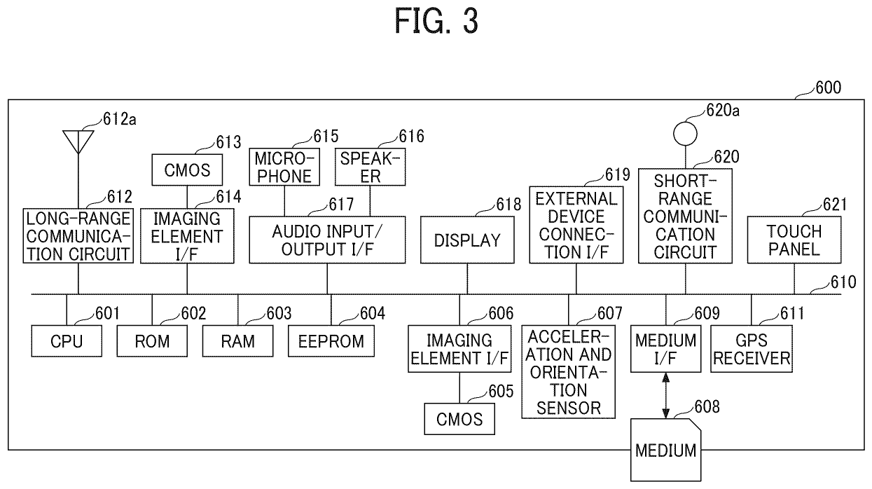

The terminal apparatuses 600 and 700 are each implemented by a smartphone. An example hardware configuration of the terminal apparatus 600 is described below with reference to FIG. 3.

FIG. 2 is a diagram illustrating an example hardware configuration of the information processing apparatus 200. The information processing apparatus 200 illustrated in FIG. 2 is implemented by a computer, and includes a central processing unit (CPU) 201, a read only memory (ROM) 202, a random access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a Digital Versatile Disk Rewritable (DVD-RW) drive 214, and a medium I/F 216.

The CPU 201 controls entire operation of the information processing apparatus 200. The ROM 202 stores a program such as an initial program loader (IPL) to boot the CPU 201. The RAM 503 is used as a work area for the CPU 201. The HD 204 stores various data such as a control program. The HDD controller 205 controls reading and writing of various data from and to the HD 204 under control of the CPU 201. The display 206 displays various information such as a cursor, menu, window, character, or image. The external device connection I/F 208 is an interface circuit that connects the computer to various external devices. Examples of the external devices include, but not limited to, a universal serial bus (USB) memory and a printer.

The network I/F 209 is an interface circuit that controls communication of data with various external devices through a communication network. The bus line 210 is an address bus or a data bus, which electrically connects the elements illustrated in FIG. 2 such as the CPU 201.

The keyboard 211 serves as an input device, and provided with a plurality of keys that allow a user to input characters, numerals, or various instructions. The pointing device 212 also serves as an input device, and allows a user to select or execute a specific instruction, select a target for processing, or move a cursor being displayed. The DVD-RW drive 214 reads and writes various data from and to a DVD-RW 213, which is an example of a removable storage medium. The removable storage medium is not limited to the DVD-RW and may be a digital versatile disc-recordable (DVD-R), for example. The medium I/F 216 controls reading or writing (storing) of data from or to a storage medium 215 such as a flash memory.

FIG. 3 is a diagram illustrating an example hardware configuration of the terminal apparatus 600. The terminal apparatus 600 includes a CPU 601, a ROM 602, a RAM 603, an electrically erasable and programmable ROM (EEPROM) 604, a complementary metal oxide semiconductor (CMOS) sensor 605, an imaging element I/F 606, an acceleration and orientation sensor 607, a medium I/F 609, a bus line 610, and a global positioning system (GPS) receiver 611.

The CPU 601 is an arithmetic processing unit, which controls entire operation of the terminal apparatus 600. The ROM 602 stores a control program for controlling the CPU 601, such as an IPL. The RAM 603 is used as a work area for the CPU 601. The EEPROM 604 reads or writes various data such as a control program for a smartphone under control of the CPU 601. The ROM 602, the RAM 603, and the EEPROM 604 are examples of storage devices for the terminal apparatus 600.

The CMOS sensor 605 is an example of a built-in imaging device that captures an object (for example, a self-image of a user operating the terminal apparatus 600) under control of the CPU 601 to obtain image data. In alternative to the CMOS sensor 605, imaging means such as a charge-coupled device (CCD) sensor may be used.

The imaging element I/F 606 is a circuit that controls driving of the CMOS sensor 605. Example of the acceleration and orientation sensor 607 includes an electromagnetic compass or gyrocompass for detecting geomagnetism and an acceleration sensor. The medium I/F 609 controls reading and writing (storing) of data from and to a storage medium 608 such as a flash memory. The GPS receiver 611 receives a GPS signal from a GPS satellite.

The terminal apparatus 600 further includes a long-range communication circuit 612, an antenna 612a for the long-range communication circuit 612, a CMOS sensor 613, an imaging element I/F 614, a microphone 615, a speaker 616, an audio input/output (I/O) I/F 617, a display 618, an external device connection I/F 619, a short-range communication circuit 620, an antenna 620a for the short-range communication circuit 620, and a touch panel 621.

The long-range communication circuit 612 is a circuit that enables the terminal apparatus 600 to communicate with other devices through the communication network. The CMOS sensor 613 is an example of a built-in imaging device that captures an object under control of the CPU 601 to obtain image data. The imaging element I/F 614 is a circuit that controls driving of the CMOS sensor 613. The microphone 615 is a built-in circuit that converts sound into an electrical signal (audio signal). The speaker 616 is a built-in circuit that generates sound such as music or voice by converting an electrical signal into physical vibration. The audio input/output I/F 617 is a circuit for inputting or outputting an audio signal between the microphone 615 and the speaker 616 under control of the CPU 601.

The display 618, which serves as a display means, displays an image of the object, various icons, for example. Examples of the display 618 include a liquid crystal display (LCD) and an organic electroluminescence (EL) display. The external device connection I/F 619 is an interface that connects the terminal apparatus 600 to various external devices. The short-range communication circuit 620 is a communication circuit that communicates in compliance with the near field communication (NFC), the BLUETOOTH, for example. The touch panel 621, which serves as an input device, allows a user to operate the terminal apparatus 600 by touching a screen of the display 618. The display 618 serves as a display unit included in the terminal apparatus 600.

The bus line 610 is an address bus or a data bus, which electrically connects the elements illustrated in FIG. 3 such as the CPU 601.

The hardware configuration illustrated in FIG. 3 is one example of the hardware configuration of the terminal apparatus 600, such that the terminal apparatus 600 may have a hardware configuration other than that of FIG. 3. For example, the hardware configuration of the terminal apparatus 600 may be the configuration illustrated in FIG. 2.

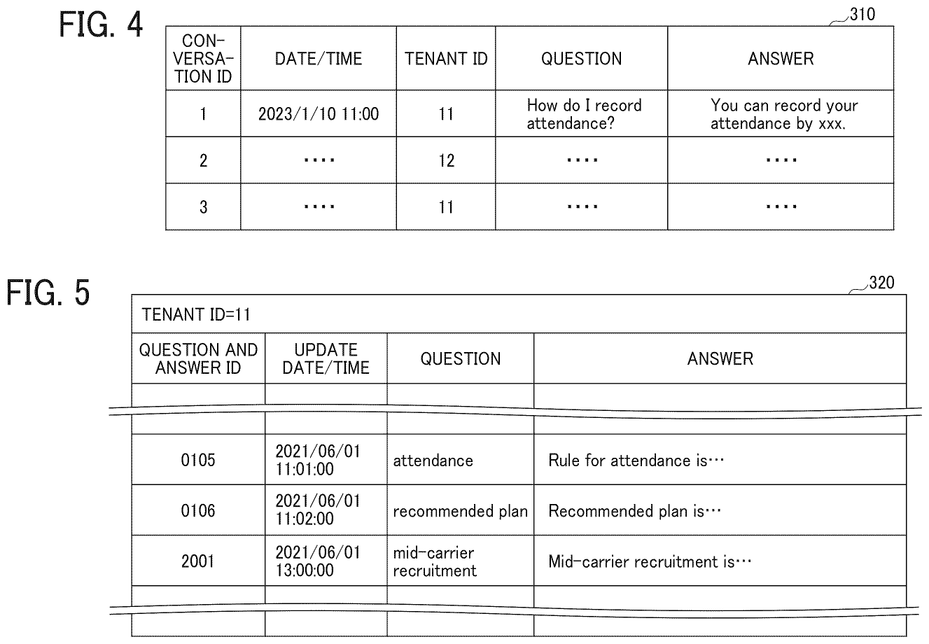

Each database managed for the chat system 100 is described below with reference to FIGS. 4 to 7. FIG. 4 is a table illustrating the conversation history DB 310.

The conversation history information stored in the conversation history DB 310 illustrated in FIG. 4 includes, as data items, a conversation ID, date and time, a tenant ID, a question, and an answer, which are associated with one another.

The “conversation ID” item has a value, which is an identifier for identifying a conversation. The conversation includes a set of question and answer. The item “date and time” has a value indicating the date and time when a question is input to the terminal apparatus 600 or the date and time when an answer is output to the terminal apparatus 600. The item “tenant ID” has a value, which is an identifier for identifying a tenant to which the user operating the terminal apparatus 600 belongs. The terminal apparatus 600 is a particular terminal apparatus that has received the question input by the user.

The item “question” has a value indicating data (question data) input to the terminal apparatus 600, and is expressed as a sentence including the question. The item “answer” has a value indicating data (answer data) output to the terminal apparatus 600, and is expressed as a sentence including the answer.

In the following description, data output to the terminal apparatus 600 as an answer is referred to as output answer data. In other words, the conversation history information includes one or more pieces of conversation history information each related to a conversation including a set of question and answer. Specifically, the conversation history information includes the conversation ID for identifying the conversation history information, the tenant ID of the tenant to which the user of the terminal apparatus 600 belongs, the date and time when the question data is input or the date and time when the output answer data is output, the question data, and the output answer data.

The data items of the conversation history information illustrated in FIG. 4 is one example, such that the conversation history information may include data items other than the data items illustrated in FIG. 4.

FIG. 5 is a table illustrating the question and answer DB 320. The question and answer information stored in the question and answer DB 320 may be provided and managed for each tenant. In the example of FIG. 5, the question and answer information managed for the tenant identified with the tenant ID “11” is described.

The question and answer information includes, as data items, a tenant ID, a question and answer ID, an update date and time, a question, and an answer. The items “tenant ID” and the item “question and answer ID” are associated with the other data items. In other words, the question and answer information managed for a particular tenant ID includes a plurality of pieces of question and answer information. Each question and answer information, which is identified with the value of the item “question and answer ID”, has the values of the other items that are associated with the item “question and answer ID”.

The item “question and answer ID” has a value indicating an identifier for identifying question and answer information. The item “update date and time” has a value indicating the date and time when the question and answer information is updated. The item “question” has a value indicating question data (text data) representing a question. The item “answer” has a value indicating answer data (text data) representing an answer. The values of the item “question” and the item “answer” are previously stored by the administrator for each tenant.

In the following description, the question data stored in the question and answer DB 320 by the administrator of each tenant is referred to as registered question data. The answer data stored in the question and answer DB 320 by the administrator of each tenant is referred to as registered answer data.

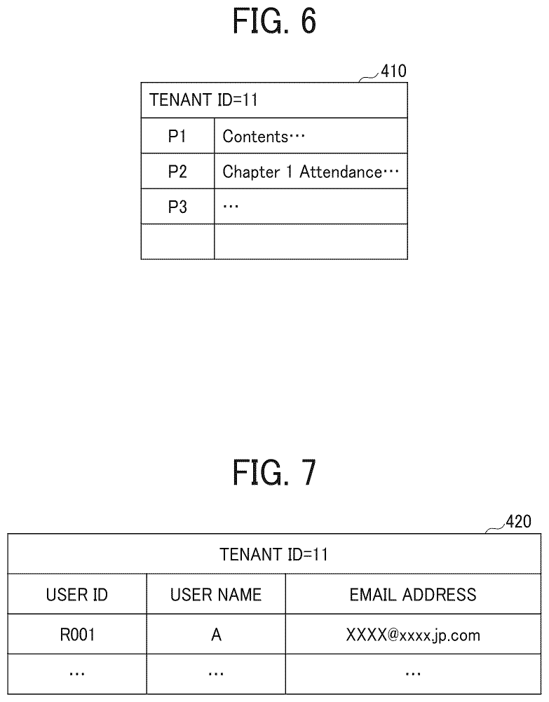

FIG. 6 is a table illustrating the document DB 410. The document DB 410 may store and manage in-company information for each tenant. FIG. 6 illustrates, as an example, in-company information that is managed for a particular tenant identified with a tenant ID “11”.

For example, the in-company information are divided into a number of preset units, and the divided units of the in-company information are separately stored in the document DB 410. In the following description, each divided unit of the in-company information is referred to as a chunk or chunk data. In the document DB 410, the chunk data may be stored in association with an identifier for identifying that chunk data.

In FIG. 6, one chunk is previously set to correspond to one page of the in-company information. The identifier identifying the chunk number is set to be the same as a page number of the particular page of the in-company information. The chunk does not have to correspond to one page of the in-company document, and may correspond to, for example, one paragraph or one chapter of the in-company document.

FIG. 7 is a table illustrating the user information DB 420. The user information DB 420 may store and manage in-company information for each tenant.

The user information includes, as data items, a tenant ID, a user ID, a user name, and an email address. The item “tenant ID” has a value, which is an identifier for identifying a tenant to which the user operating the terminal apparatus 600 belongs. The terminal apparatus 600 is a particular terminal apparatus that has received the question input by the user. The item “user ID” has a value, which is an identifier for identifying a user operating the terminal apparatus 600. The item “user name” has a value indicating the name of the user identified with the user ID. The item “email address” has a value indicating the email address of the user identified with the user ID. The user information may include information indicating the attributes of the user. The information indicating the attributes of the user may be, for example, information indicating a department to which the user belongs.

In the above-described example, the second storage device 400 includes the user information DB 420. Alternatively, the user information DB 420 may not be provided for the second storage device 400. In such a case, only the document DB 410 may be provided for the second storage device 400.

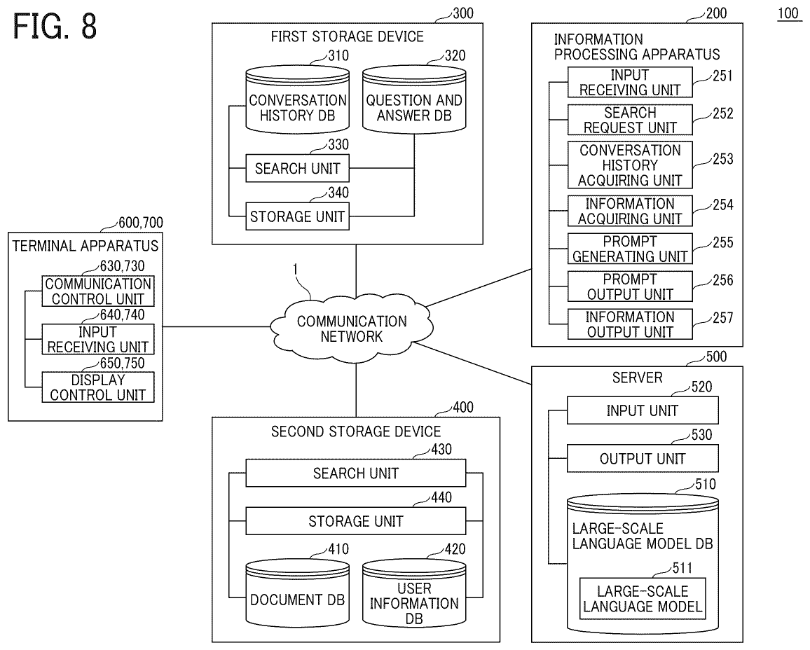

A functional configuration of each apparatus or device in the chat system 100 is described below with reference to FIG. 8. FIG. 8 is a diagram illustrating functional configurations of the apparatuses or devices included in the chat system 100.

First, the functional configuration of the information processing apparatus 200 is described below. The information processing apparatus 200 includes an input receiving unit 251, a search request unit 252, a conversation history acquiring unit 253, an information acquiring unit 254, a prompt generating unit 255, a prompt output unit 256, and an information output unit 257.

The input receiving unit 251 receives various inputs to the information processing apparatus 200. Specifically, the input receiving unit 251 receives inputs of question data from the terminal apparatus 600.

The search request unit 252 requests the first storage device 300 or the second storage device 400 to conduct search. Specifically, the search request unit 252 transmits, to the first storage device 300, a search request for searching the conversation history DB 310 using the question data as a search key. The search request unit 252 transmits, to the second storage device 400, a search request for searching the document DB 410 based on a query generated by the server 500.

The conversation history acquiring unit 253 acquires conversation history information from the first storage device 300. The conversation history information is a search result obtained through searching the conversation history DB 310 according to the search request by the search request unit 252.

The information acquiring unit 254 acquires in-company information from the second storage device 400. The in-company information is a search result obtained through searching the document DB 410 according to the search request by the search request unit 252.

The prompt generating unit 255 generates a prompt to be output to the server 500. For example, when information to be included in a prompt is acquired, the prompt generating unit 255 generates a prompt including the acquired information in a predetermined format.

The prompt output unit 256 outputs the prompt generated by the prompt generating unit 255 to the server 500. The information output unit 257 outputs various kinds of information from the information processing apparatus 200.

The functional configuration of the first storage device 300 is described below. The first storage device 300 includes the conversation history DB 310, the question and answer DB 320, a search unit 330 and a storage unit 340. The search unit 330 searches the conversation history DB 310 or the question and answer DB 320 in response to a search request from the information processing apparatus 200, and transmits a search result to the information processing apparatus 200. When question data is input to the information processing apparatus 200 and output answer data is output from the information processing apparatus 200, the storage unit 340 stores conversation history information including the question data and the output answer data in the conversation history DB 310.

The functional configuration of the second storage device 400 is described below. The second storage device 400 includes the document DB 410, the user information DB 420, a search unit 430, and a storage unit 440. The search unit 330 searches the conversation history DB 310 or the question and answer DB 320 in response to a search request from the information processing apparatus 200, and transmits a search result to the information processing apparatus 200. In response to an operation of uploading in-company information by the administrator of the chat system 100, the storage unit 440 newly stores the in-company information in the document DB 410.

The functional configuration of the server 500 is described below. The server 500 includes the large-scale language model DB 510, an input unit 520, and an output unit 530. The large-scale language model DB 510 stores the large-scale language model 511 for implementing the generative AI.

The large-scale language model 511 is a computer language model that is generated by executing a learning process using an enormous amount of unlabeled text as learning data and is developed on an artificial neural network having a large number of parameters. The large-scale language model 511 has been sufficiently trained with any desired method for learning a context, such as the next sentence prediction or the masked language model, to capture many of syntax and meanings of human words.

The next sentence prediction understands the context by determining whether a sentence 1 and a sentence 2 are continuous. The masked language model understands the context by masking a word in a sentence and predicting the masked word from the words before and after the masked word.

The input unit 520 inputs a prompt transmitted from the information processing apparatus 200 to the large-scale language model 511. The output unit 530 outputs (transmits) output data output from the large-scale language model 511 to the information processing apparatus 200. In other words, the output unit 530 transmits the output answer data output from the large-scale language model 511 to the information processing apparatus 200.

The functional configurations of the terminal apparatuses 600 and 700 area described below. The terminal apparatuses 600 and 700 include communication control units 630 and 730, input receiving units 640 and 740, and display control units 650 and 750, respectively.

The communication control units 630 and 730 control communication between the terminal apparatuses 600 and 700 and the information processing apparatus 200. The input receiving units 640 and 740 receive inputs to the terminal apparatuses 600 and 700. The display control units 650 and 750 control display in the terminal apparatuses 600 and 700.

### First Example

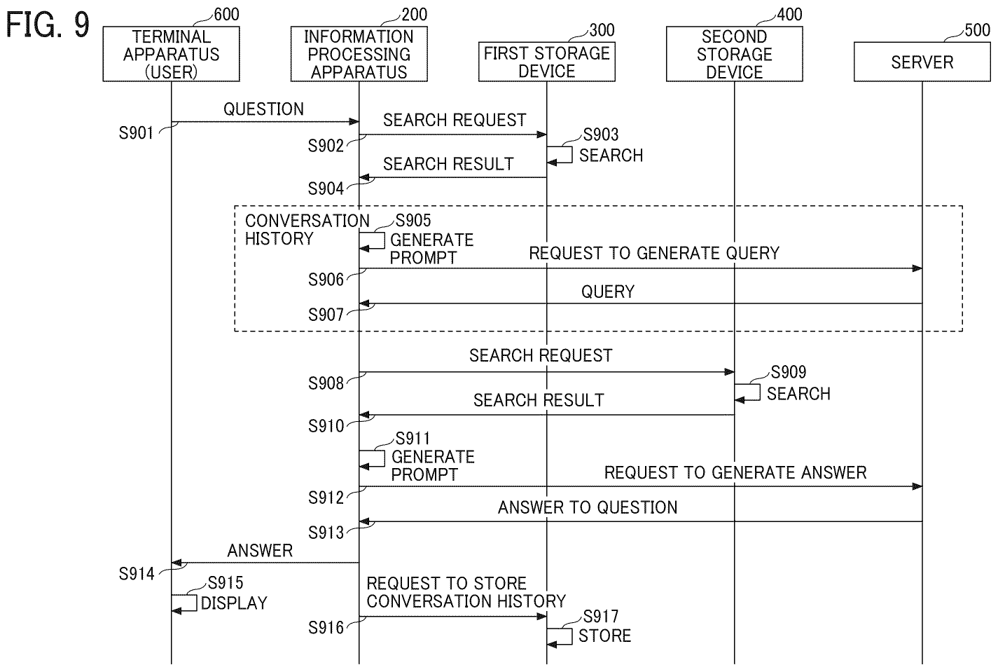

An example operation performed by the chat system 100 is described below with reference to FIG. 9. FIG. 9 is a sequence diagram illustrating the example operation performed by the chat system 100.

At S901, in response to receiving input of a question by the input receiving unit 640, the terminal apparatus 600 of the chat system 100 transmits the question data indicating the input question to the information processing apparatus 200. The question data being transmitted may be assigned with a tenant ID identifying a tenant to which the user operating the terminal apparatus 600 belongs.

At S902, in response to receiving the question data by the input receiving unit 251, the search request unit 252 of the information processing apparatus 200 transmits a search request including the tenant ID to the first storage device 300.

At S903, in response to receiving the search request, the search unit 330 of the first storage device 300 searches the conversation history DB 310.

The process performed by the search unit 330 is described below. The search unit 330 specifies conversation history information including the tenant ID, which is obtained from the search request, from among the conversation history information stored in the conversation history DB 310. The search unit 330 acquires, from among the specified conversation history information, conversation history information having contents related to the question indicated by the question data, as a search result.

Specifically, the search unit 330 acquires conversation history information for the conversations that have continued until immediately before the question is input at S901, from the specified conversation history information including the tenant ID of the search request.

The conversations that have continued until immediately before the question is input at S901, are assumed to have a time period between the time when the question is input and the time when the answer is output immediately before the question is input, which falls within a preset time period. When next question data is input within the preset time period after the output answer data is output, a series of questions and answers are regarded as responses related to the same inquiry.

As described above, the chat system 100 acquires the conversation history information having contents that are related to the question indicated by the question data.

At S904, the search unit 330 of the first storage device 300 searches the conversation history DB 310 to obtain a search result, and transmits the search result to the information processing apparatus 200. The conversation history acquiring unit 253 of the information processing apparatus 200 acquires the search result, which is the conversation history information.

When the conversation history information is acquired from the first storage device 300 as the search result, the information processing apparatus 200 performs the steps S905 to S907.

It is determined that the conversation history information, which is the search result, is acquired, when another question related to the question indicated by the question data input at S901 is input, and an answer to that question being input is output, before another input of question data is received in a similar manner as S901. In such a case, the conversation history information including the input question data and the output answer data is stored in the conversation history DB 310.

When it is determined that the conversation history information, which is the search result, is not acquired from the first storage device 300, the operation proceeds to S908 without performing S905 to S907. It is determined that the conversation history information is not acquired, when the question data input at S901 indicates the first question in the inquiry.

At S905, the prompt generating unit 255 of the information processing apparatus 200 generates a prompt, which requests generation of a query for searching the document DB 410.

At this time, the prompt generating unit 255 generates a prompt for requesting generation of a query based on the question data and the conversation history information. The prompt includes the question data input at S901 and the conversation history information acquired by the conversation history acquiring unit 253.

At S906, the prompt output unit 256 of the information processing apparatus 200 transmits, to the server 500, the prompt for requesting generation of a query.

At S907, at the server 500, the input unit 520 inputs the prompt to the large-scale language model 511 to request generation of the query. The output unit 530 transmits the output data output from the large-scale language model 511, which is the query, to the information processing apparatus 200.

At S908, at the information processing apparatus 200, the search request unit 252 transmits a search request for in-company information to the document DB 410 of the second storage device 400. This in-company information may become an information source for generating output answer data to the question data.

Specifically, when the search request unit 252 acquires the query at S907, the search request unit 252 transmits a search request based on the acquired query to the second storage device 400. When the search request unit 252 does not acquire the query, that is, when the conversation history information is not acquired at S904, the search request unit 252 transmits a search request including the question data input at S901 to the second storage device 400.

At S909, in response to receiving the search request, the search unit 430 of the second storage device 400 searches the document DB 410. At S910, the second storage device 400 transmits the in-company information, which is obtained as the search result, to the information processing apparatus 200.

At the information processing apparatus 200, when the information acquiring unit 254 acquires the in-company information, at S911, the prompt generating unit 255 generates a prompt for requesting generation of an answer to the question, using the acquired in-company information as an information source. At S912, the information processing apparatus 200 transmits the prompt for requesting generation of an answer to the server 500.

In response to receiving the prompt, at S913, the input unit 520 of the server 500 inputs the prompt to the large-scale language model 511. The output unit 530 transmits output answer data output from the large-scale language model 511 to the information processing apparatus 200.

When the information processing apparatus 200 obtains the output answer data, at S914, the information output unit 257 outputs the output answer data to the terminal apparatus 600. At S915, the display control unit 650 of the terminal apparatus 600 displays the output answer data on the display 618. Specifically, the display control unit 650 displays the output answer data on the display 618 in association with the question data being input.

At S916, the information output unit 257 of the information processing apparatus 200 transmits, to the first storage device 300, a request for storing the conversation history information that includes the question data received at S901 and the output answer data output to the terminal apparatus 600 at S914. The request for storing the conversation history information includes the tenant ID of the tenant to which the user of the terminal apparatus 600 belongs.

At S917, the storage unit 340 of the first storage device 300 stores the conversation history information in a new record of the conversation history DB 310. Specifically, the storage unit 340 assigns a new conversation ID and a new date and time, each to the question data, the output answer data, and the tenant ID, which are acquired from the information processing apparatus 200, and store these data items in the conversation history DB 310 as the conversation history information. In this way, the contents of the conversation history DB 310 are updated.

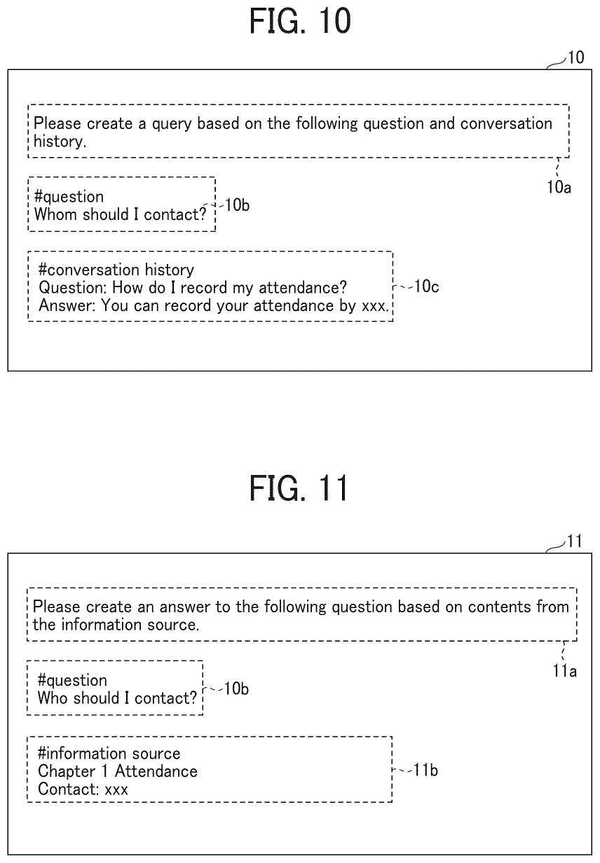

An example prompt output from the information processing apparatus 200 to the server 500 is described with reference to FIGS. 10 and 11.

FIG. 10 is a diagram illustrating a prompt 10. The prompt 10 is an example of a prompt for requesting generation of a query, which is transmitted from the information processing apparatus 200 to the server 500 at S906 of FIG. 9.

In the example of FIG. 10, the question data input to the information processing apparatus 200 at S901 of FIG. 9 is “Whom should I contact?”. The conversation history information acquired at S904 includes the question “How do I record my attendance?” and the answer “You can record your attendance by xxx.”

The prompt 10 includes text data 10a, text data 10b, and text data 10c. The text data 10a indicates a request for generating a query for searching the document DB 410 based on the question from the user of the terminal apparatus 600 and the conversation history.

The text data 10b indicates the question from the user of the terminal apparatus 600. In particular, the text data 10b includes the question data “Whom should I contact?”, which is received by the information processing apparatus 200 at S901. The text data 10c includes a set of the question and the answer included in the conversation history information acquired at S904. For example, the text data 10c includes the question “How do I record my attendance?” and the answer “You can record your attendance by xxx.” in the conversation history information acquired by the information processing apparatus 200 at S904.

By inputting this prompt 10 to the large-scale language model 511 of the server 500, the server 500 can generate a query for searching the second storage apparatus 400, using the question indicated by the input question data and the conversation history information including the contents related to the question indicated by the question data.

Further, by searching the document DB 410 of the second storage device 400 with this query, the information source used to generate the output answer data for the question data can be set to in-company information that is highly likely to include the answer to the question indicated by the question data. This improves the accuracy of the answer.

FIG. 11 is a diagram illustrating a prompt 11. The prompt 11 is an example of a prompt for requesting generation of output answer data, which is transmitted from the information processing apparatus 200 to the server 500 at S912 of FIG. 9.

The prompt 11 includes text data 11a, text data 11b, and text data 10b. The text data 11a is text data for requesting generation of output answer data to the question indicated by the question data.

The text data 11b is a source of information. The information source indicated by the text data 11b includes the in-company information acquired from the second storage device 400 at S909 of FIG. 9. In other words, the information source indicated by the text data 11b includes the in-company information acquired as a result of searching the document DB 410 with the query generated from the contents of question made by the user of the terminal apparatus 600 and the conversation history information.

By inputting the prompt 11 including the in-company information serving as the information source to the large-scale language model 511 of the server 500, the large-scale language model 511 can obtain an answer based on the information unique to the tenant.

Further, the in-company information is acquired as an information source by a search based on a query including conversation history information. Accordingly, an answer to the user's question is obtained from the large-scale language model 511 by using the in-company information that is highly likely to include contents related to the contents of the user's question as an information source, thus increasing the accuracy of the answer.

Further, a part of the in-company information stored in the document DB 410 is extracted and included in the prompt. In this way, an answer can be obtained using the in-company information as an information source, while taking into account the limits on the number of tokens that can be input to the large-scale language model 511 as a prompt.

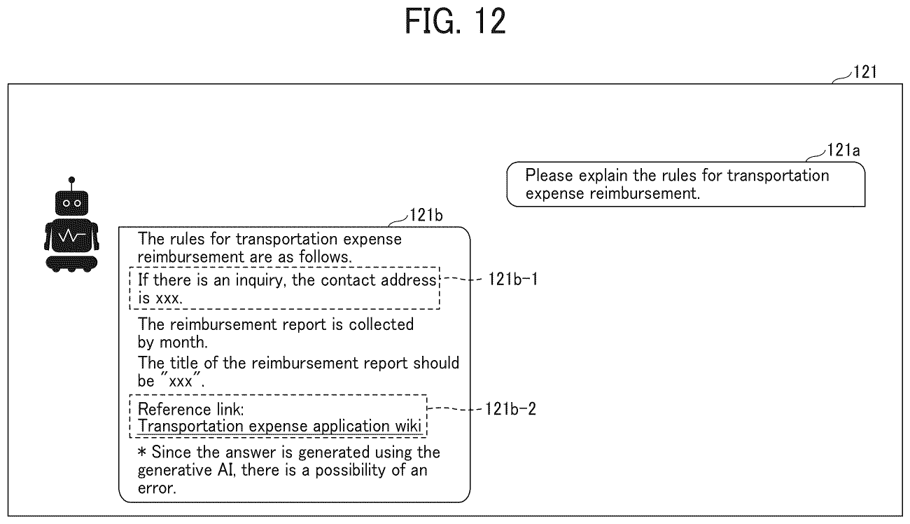

Example screens of the terminal apparatus 600 are described below with reference to FIGS. 12 to 15. FIG. 12 is a first diagram illustrating an example screen displayed by the terminal apparatus 600.

A screen 121 illustrated in FIG. 12 is an example of a screen displayed at the terminal apparatus 600 at S915 of FIG. 9.

The screen 121 includes display areas 121a and 121b. The display area 121a displays question data input by the user of the terminal apparatus 600. The display area 121b displays text data 121b-1 and a link 121b-2 in addition to the output answer data output from the chat system 100.

The text data 121b-1 includes information indicating a contact address to be used by the user of the terminal apparatus 600 to send the additional question. The information indicating the contact address may be, for example, an email address or a telephone number. The information indicating the contact address may be stored, for example, in the user information DB 420. The user information DB 420 may store information indicating a task assigned to each user in association with the user ID of each user.

When transmitting the output answer data to the terminal apparatus 600, the information processing apparatus 200 may acquire the email address of the user in charge of the task, which corresponds to the question indicated by the question data, and transmit the acquired email address to the terminal apparatus 600 together with the output answer data.

The link 121b-2 is a link for displaying information related to the contents indicated by the question data and the output answer data.

By notifying the user of the terminal apparatus 600 of the contact address for further question and the information related to the question and the answer together with the output answer data, the user can be highly satisfied with the answer.

The information processing apparatus 200 may transmit a notification indicating that the question has been received from the user of the terminal apparatus 600, to the contact address included in the text data 121b-1. With the notification, the information processing apparatus 200 prompts a user, who is the contact destination, to prepare for responding to the additional question.

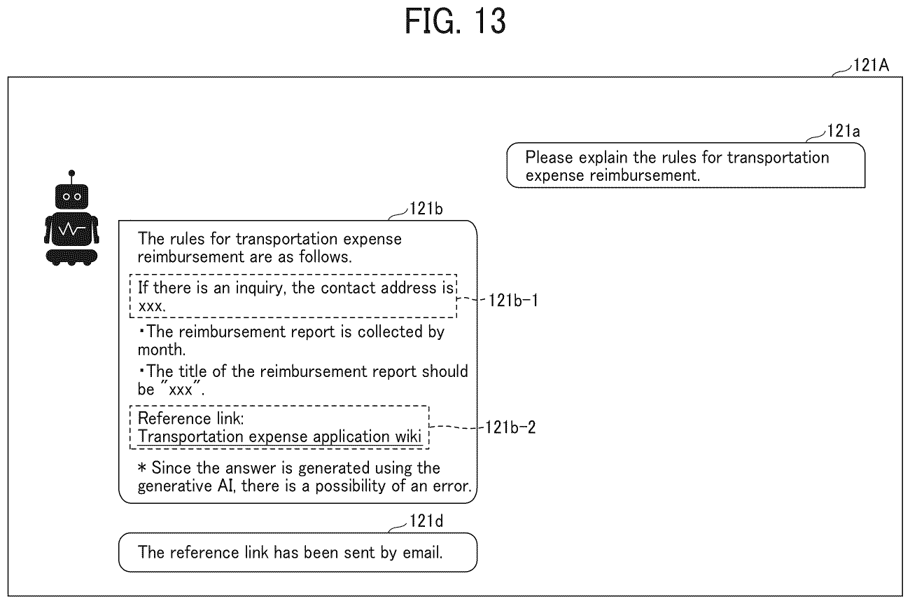

FIG. 13 is a second diagram illustrating an example screen displayed by the terminal apparatus 600. A screen 121A illustrated in FIG. 13 is another example of the screen displayed on the terminal apparatus 600 at S915 of FIG. 9.

The screen 121A includes display areas 121a, 121b, and 121d. The display area 121d displays a message notifying that the link 121b-2 displayed in the display area 121b has been transmitted to the email address of the user of the terminal apparatus 600.

In this case, the user ID of the user of the terminal apparatus 600 may be input to the information processing apparatus 200 together with the question data. The information processing apparatus 200 may refer to the user information DB 420 and acquire the email address identified using the tenant ID and the user ID. The information processing apparatus 200 may transmit the link 121b-2 to the identified email address together with the output answer data when transmitting the output answer data to the terminal apparatus 600, and then display the display area 121d on the terminal apparatus 600.

In the example of FIG. 13, with the transmission of the link 121b-2 for displaying the information related to the user's question to the user's email address, the user can refer to the information related to the question even after the user finishes using the chat system 100.

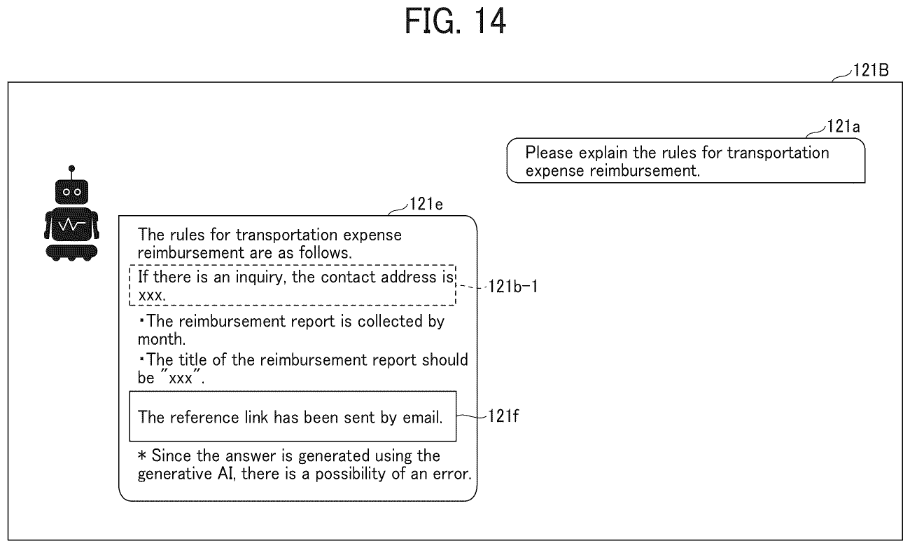

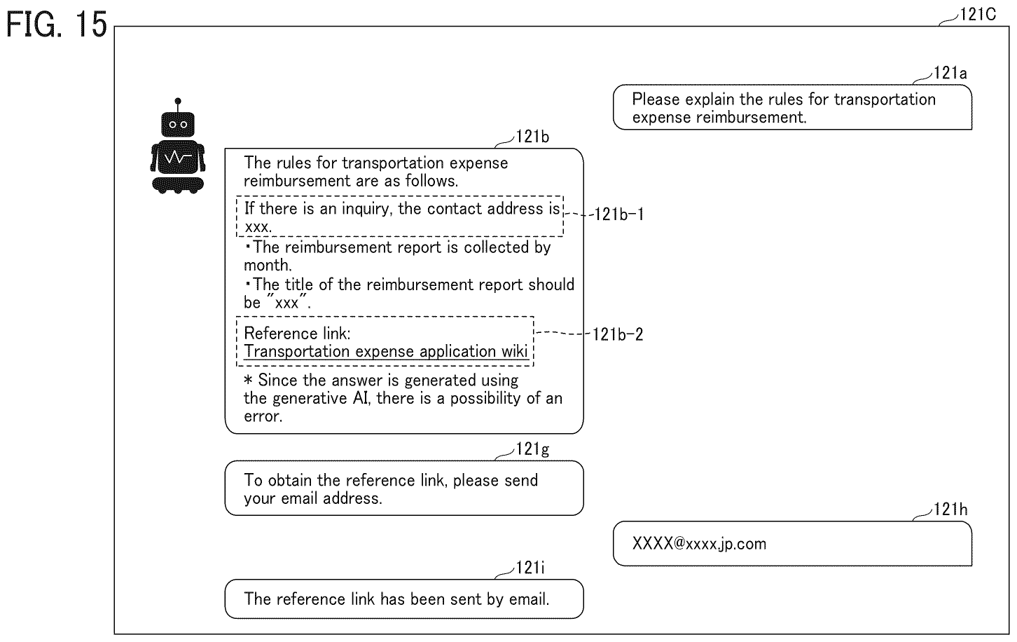

FIG. 14 is a third diagram illustrating an example screen displayed by the terminal apparatus 600. A screen 121B illustrated in FIG. 14 is another example of the screen displayed on the terminal apparatus 600 at S915 of FIG. 9.

The screen 121B includes display areas 121a and 121e. The display area 121e displays text data 121b-1 and a message 121f. The message 121f is a message indicating that a link for displaying information related to the user's question has been transmitted to the user's email address.

In the example of FIG. 14, the user can be notified of a link for displaying information related to the user's question separately from the output answer data.

FIG. 15 is a fourth diagram illustrating an example screen displayed by the terminal apparatus 600. A screen 121C illustrated in FIG. 15 is another example of the screen displayed on the terminal apparatus 600 at S915 of FIG. 9. The screen 121C may be displayed when the user's email address is not stored in the user information DB 420 of the second storage device 400.

The screen 121C includes display areas 121a, 121b, 121g, 121h, and 121i. The display area 121g displays a message requesting a transmission destination of the link 121b-2. The display area 121h displays an email address input by the user. The display area 121i displays a message notifying that the link 121b-2 has been transmitted to the email address input by the user.

In the example of FIG. 15, even when the email address of the user is not stored in the user information DB 420, the link 121b-2 can be transmitted to an address input by the user if the user desires.

### Second Example

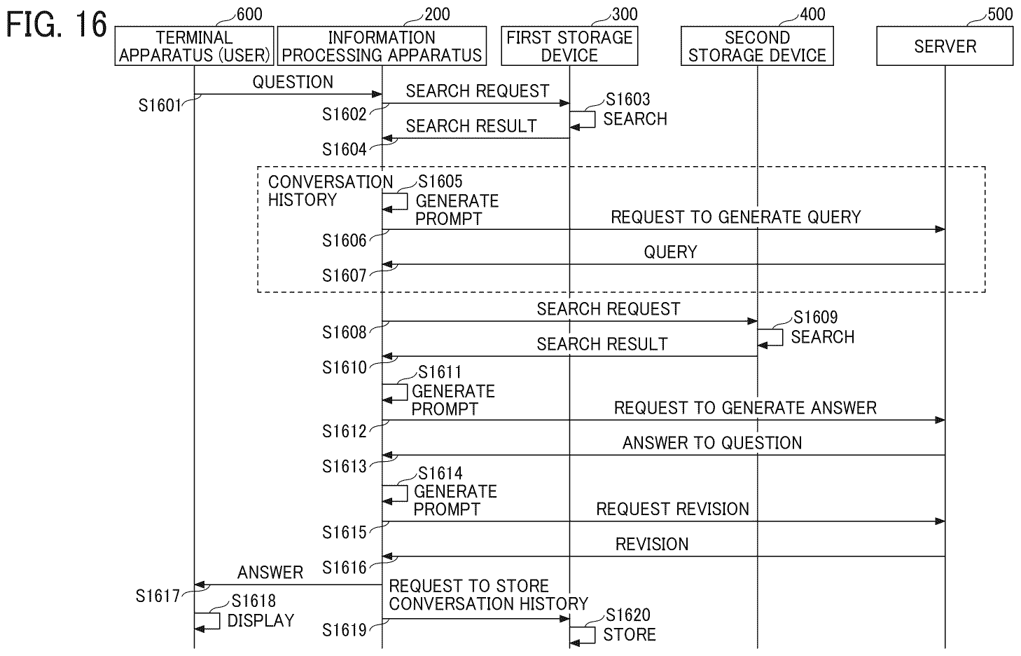

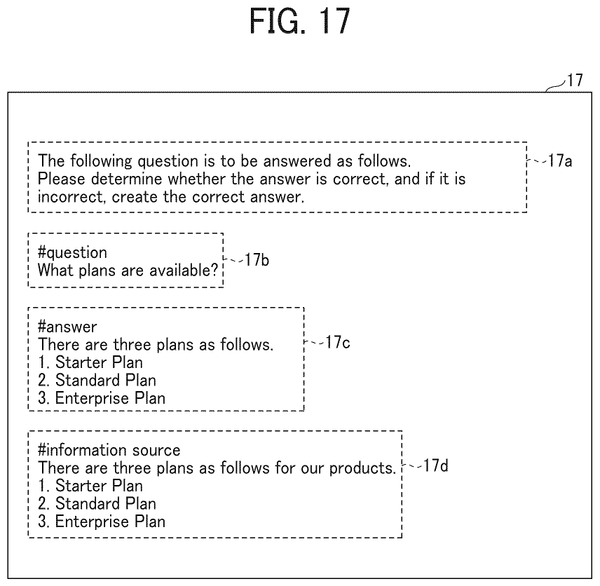

Another example operation performed by the chat system 100 is described below with reference to FIGS. 16 and 17. The following example is different from the example of FIG. 9 in that the server 500 is caused to revise the output answer data generated by the large-scale language model 511. In the following description, differences from the first example are described. The same reference numerals are given to the same or corresponding functions or configurations as those of the first example, and redundant descriptions thereof are omitted or simplified appropriately.

FIG. 16 is a sequence diagram illustrating the example operation performed by the chat system 100.

Since the processes from S1601 to S1613 of FIG. 16 are the same as the processes from S901 to S913 of FIG. 9, the description thereof is omitted.

When the information processing apparatus 200 acquires the output answer data from the server 500, at S1614, the prompt generating unit 255 generates a prompt requesting revision of the output answer data. At S1615, the information processing apparatus 200 transmits the generated prompt to the server 500. In response to receiving the prompt requesting revision, at S1616, the input unit 520 of the server 500 inputs the prompt to the large-scale language model 511. The output unit 530 transmits output data output from the large-scale language model 511 to the information processing apparatus 200 as output answer data.

When it is determined through the revision that the output answer data output at S1613 is not appropriate, the server 500 may transmit a revised answer to the information processing apparatus 200 as a result of the revision. Even when it is determined that the output answer data output at S1613 is appropriate, the server 500 may transmit the output answer data output at S1613 to the information processing apparatus 200 again as a result of the revision.

At S1617, the information processing apparatus 200 transmits the revision result data received from the server 500 to the terminal apparatus 600 as output answer data to the question data.

Since the processes from S1617 to S1620 of FIG. 16 is the same as the processes from S914 to S917 of FIG. 9, the description thereof is omitted.

The prompt generated at S1614 is described below with reference to FIG. 17. FIG. 17 is a diagram illustrating an example of a prompt.

The prompt 17 illustrated in FIG. 17 is a prompt for requesting revision of the output answer data output by the large-scale language model 511.

The prompt 17 includes text data 17a, text data 17b, text data 17c, and text data 17d. The text data 17a indicates contents of a request requesting revision of output answer data output from the large-scale language model 511. The text data 17b indicates the contents of a question from the user of the terminal apparatus 600. In particular, the text data 17b includes the question data “What plans area available?”, which is received by the information processing apparatus 200 at S1601.

The text data 17c includes the output answer data acquired by the information processing apparatus 200 at S1613 of FIG. 16. In particular, the text data 17c includes the output answer data obtained by the information processing apparatus 200 at S1613: “There are three plans as follows. 1. Starter Plan 2. Standard Plan 3. Enterprise Plan”.

The text data 17d indicates the in-company information acquired by the information processing apparatus 200 at S1610 of FIG. 16 as an information source.

In the examples of FIGS. 16 and 17, as described above, the large-scale language model 511 revises the output answer data output by itself to determine whether there is improper contents. It is thus possible to prevent an improper answer from being output to the user of the terminal apparatus 600, thus increasing the accuracy of the answer.

### Third Example

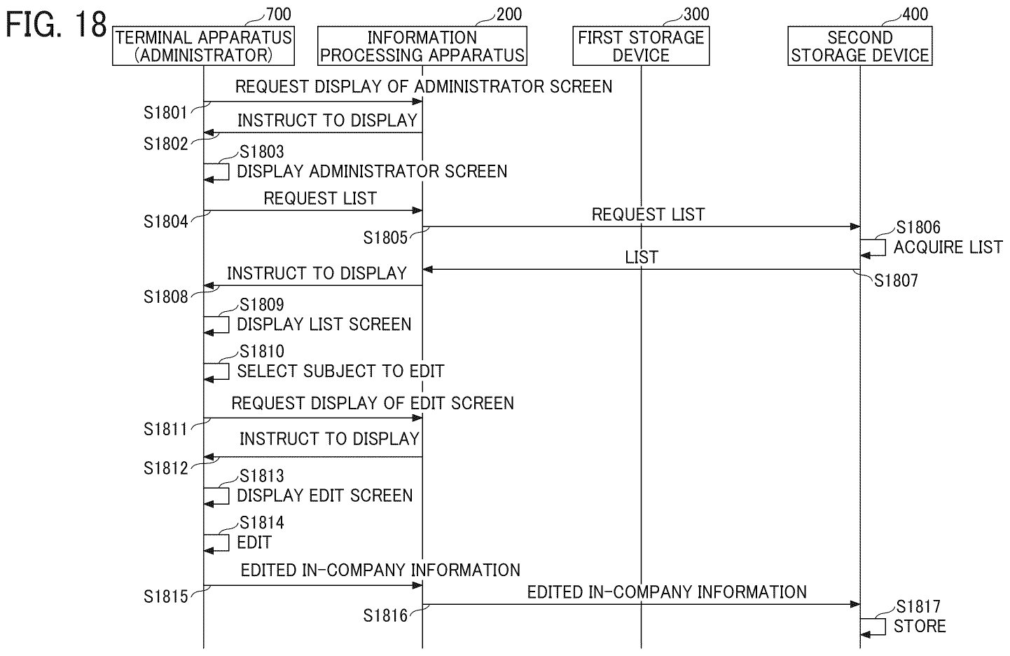

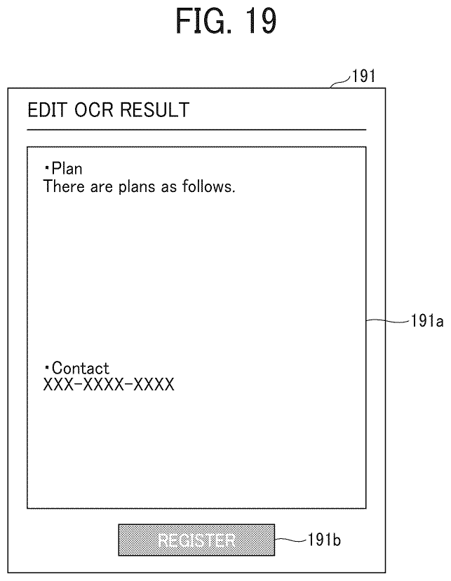

Another example operation performed by the chat system 100 is described below with reference to FIGS. 18 and 19. The following example is different from the example of FIG. 9 in that the in-company information stored in the document DB 410 can be edited. In the following description, differences from the first example are described. The same reference numerals are given to the same or corresponding functions or configurations as those of the first example, and redundant descriptions thereof are omitted or simplified appropriately.

FIG. 18 is a sequence diagram illustrating the example operation performed by the chat system 100.

FIG. 18 illustrates the operation performed by the chat system 100 when the administrator, who manages the in-company information, edits the in-company information stored in the document DB 410.

At S1801, the terminal apparatus 700 of the chat system 100 transmit a request for displaying an administrator screen of the chat system 100 to the information processing apparatus 200. At S1802, the information processing apparatus 200 receives the displaying request and transmits an instruction for displaying the administrator screen to the terminal apparatus 700.

At S1803, the display control unit 750 of the terminal apparatus 700 displays an administrator screen. The administrator screen may include, for example, an operation button for transitioning to a screen for editing, adding (uploading), or deleting in-company information.

At S1803 of FIG. 18, it is assumed that the operation for editing in-company information is performed on the administrator screen.

When the user operation for editing the in-company information is received, at S1804, the terminal apparatus 700 transmits to the information processing apparatus 200 a request for obtaining a list of in-company information of a tenant to which the user of the terminal apparatus 700 belongs. The request for obtaining the list includes a tenant ID of the tenant to which the user of the terminal apparatus 700 belongs.

When the information processing apparatus 200 receives the request for obtaining the list, at S1805, the information acquiring unit 254 transmits the request for obtaining the list including the tenant ID to the second storage apparatus 400.

The second storage device 400 receives the request for obtaining the list, and at S1806, obtains a list of in-company information associated with the tenant ID, included in the request for obtaining the list, from among the in-company information stored in the document DB 410. At S1807, the second storage device 400 transmits the list of in-company information to the information processing apparatus 200. When the list is obtained, at S1808, the information processing apparatus 200 transmits an instruction to display the obtained list to the terminal apparatus 700. The list of in-company information may be a list of chunk data stored in the document DB 410.

In response to the instruction to display, the terminal apparatus 700 displays a list screen that lists the in-company information at S1809. At S1810, the terminal apparatus 700 receives an operation of selecting particular in-company information to be edited from the list screen. At S1811, the terminal apparatus 700 transmits a request for editing the selected in-company information to the information processing apparatus 200. The request for editing may include identification information for identifying the selected in-company information (chunk data).

When the information processing apparatus 200 receives the request for editing, at S1812, the information processing apparatus 200 transmits an instruction to display an edit screen of the selected in-company information to the terminal apparatus 700.

In response to the instruction to display, at S1813, the terminal apparatus 700 displays the edit screen of the selected in-company information. At S1814, the terminal apparatus 700 receives an editing operation.

When the editing operation is completed, at S1815, the terminal apparatus 700 transmits the edited in-company information to the information processing apparatus 200. In response to receiving the edited in-company information, at S1816, the information processing apparatus 200 transmits the edited in-company information to the second storage device 400.

At S1817, the storage unit 440 of the second storage device 400 stores the edited in-company information in the document DB 410. More specifically, the storage unit 440 may overwrite the in-company information in the document DB 410, which is selected as the editing target, with the edited in-company information.

The edit screen displayed on the terminal apparatus 700 is described below. FIG. 19 is a diagram illustrating an example screen displayed by the terminal apparatus 700.

A screen 191 illustrated in FIG. 19 is an example of a screen displayed at the terminal apparatus 700 at S1813 of FIG. 18.

The screen 191 includes a display area 191a and an operation button 191b. The display area 191a displays the in-company information selected at S1810 of FIG. 18. The in-company information displayed in the display area 191a may be, for example, information obtained by converting an in-company document printed on paper into text, for example, by optical character recognition (OCR) processing.

The user of the terminal apparatus 700 may edit the text data of the in-company information displayed in the display area 191a, for example, by entering information.

The operation button 191b, when selected, causes transmission of the text data displayed in the display area 191a to the information processing apparatus 200 as the edited in-company information.

When the operation button 191b is operated, the terminal apparatus 700 transmits the in-company information displayed in the display area 191a at the time of the operation on the operation button 191b to the information processing apparatus 200 as the edited in-company information.

In this way, for example, even when reading by the OCR processing fails or erroneous recognition occurs, the administrator can correct the failure or the erroneous recognition. Accordingly, the in-company information, which is an information source to be provided to the server 500, can be made more accurate. This prevents the output answer data having erroneous contents from being output in response to question data.

### Fourth Example

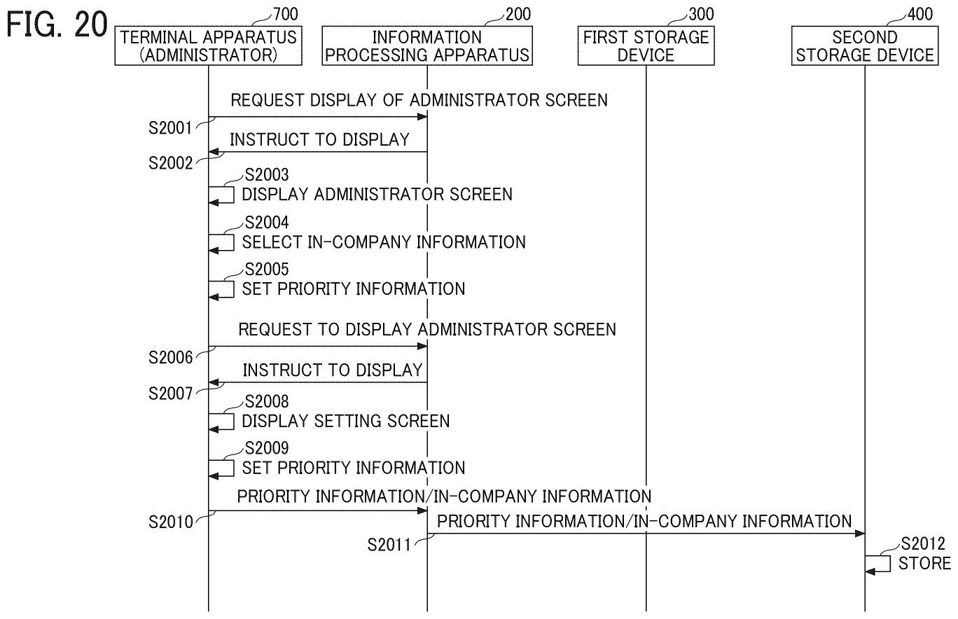

Another example operation performed by the chat system 100 is described below with reference to FIGS. 20 to 22. The following example is different from the example of FIG. 9 in that information to be referred to can be set in priority, as the information source provided to the server 500. In the following description of the fourth example, differences from the first example are described. The same reference numerals are given to the same or corresponding functions or configurations as those of the first example, and redundant descriptions thereof are omitted or simplified appropriately.

FIG. 20 is a sequence diagram illustrating the example operation performed by the chat system 100.

The processes from S2001 to S2003 of FIG. 20 are the same as the processes from S1801 to S1803 of FIG. 18, and the description thereof is omitted.

At S2003 of FIG. 20, it is assumed that an operation for adding in-company information is performed on the administrator screen.

At S2004, the terminal apparatus 700 receives an operation of selecting the in-company information to be uploaded. When an instruction to set priority information to be referred to in priority for the in-company information selected at S2005 is received, at S2006, the terminal apparatus 700 transmits a display request for displaying a setting screen of the priority information to the information processing apparatus 200.

When the information processing apparatus 200 receives the request for displaying the setting screen of the priority information, at S2007, the information processing apparatus 200 transmits an instruction for displaying the setting screen of the priority information to the terminal apparatus 700. The terminal apparatus 700 receives the instruction for displaying and displays the setting screen of the priority information at S2008.

At S2009, the terminal apparatus 700 receives an operation for setting the priority information. When the setting is completed, at S2010, the terminal apparatus 700 transmits the in-company information to be added and the priority information to the information processing apparatus 200. At this time, the tenant ID of the tenant to which the user of the terminal apparatus 700 belongs is assigned to the in-company information and the priority information.

In response to receiving the in-company information and the priority information each assigned with the tenant ID, at S2011, the information processing apparatus 200 transmits the in-company information and the priority information to the second storage device 400.

When the second storage device 400 receives the in-company information and the priority information each assigned with the tenant ID, the storage unit 440 stores the in-company information and the priority information each assigned with the tenant ID in the document DB 410.

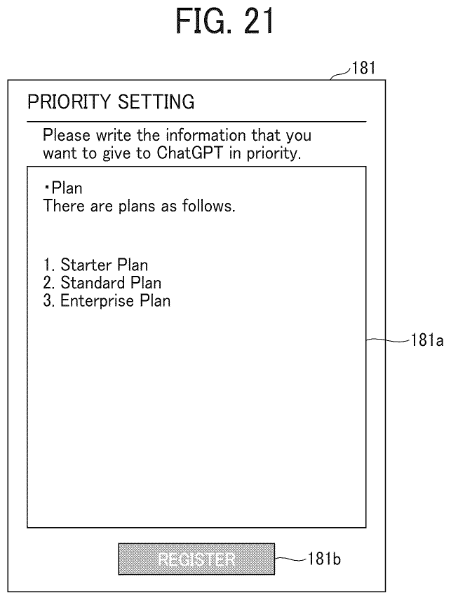

The setting screen of the priority information is described below with reference to FIG. 21. FIG. 21 is a diagram illustrating an example screen displayed by the terminal apparatus 700.

FIG. 21 illustrates a screen 181A, which is one example of a setting screen of priority information, displayed on the terminal apparatus 700 at S2009 of FIG. 20.

The screen 181 includes an input field 181a and an operation button 181b. The input field 181a is an input field for inputting priority information. The operation button 181b is an operation button which, when selected, causes to store the priority information input to the input field 181a in association with the in-company information.

In response to operation of the operation button 181b after the in-company information to be uploaded is selected and the priority information is input to the input field 181a, the terminal apparatus 700 transmits the input priority information and the selected in-company information, which are associated, to the information processing apparatus 200.

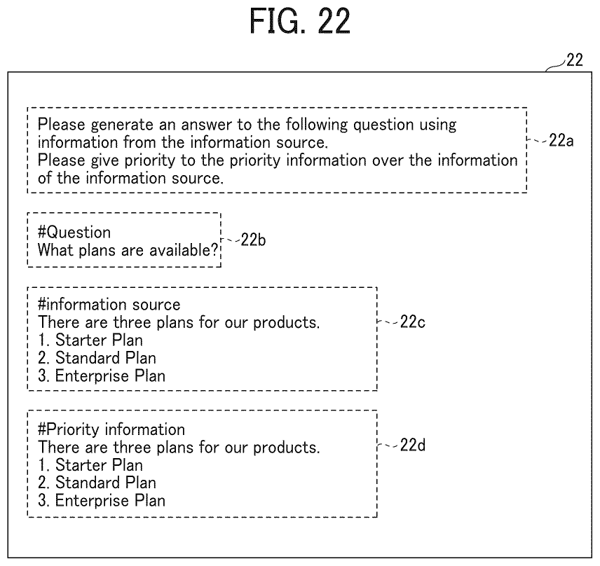

A prompt in the case where the priority information is associated with the in-company information is described below with reference to FIG. 22.

FIG. 22 is a diagram illustrating an example of a prompt. The prompt 22 illustrated in FIG. 22 is an example of a prompt for requesting generation of an answer, which is transmitted from the information processing apparatus 200 to the server 500, for example, at S912 of FIG. 9.

The prompt 22 includes text data 22a, text data 22b, text data 22c, and text data 22d. The text data 22a indicates a request for generating an answer based on the information source in response to the question from the user of the terminal apparatus 600, and for referring to the priority information when the information source is associated with the priority information.

The text data 22b indicates the contents of the question from the user of the terminal apparatus 600. The text data 22c is a source of information. The information source indicated by the text data 22c includes the in-company information acquired from the second storage device 400 at S909 of FIG. 9. The text data 22d indicates the priority information associated with the information resource indicated by the text data 22c.

By inputting the prompt 22 to the large-scale language model 511 of the server 500, the output answer data, in which the priority information previously set is referred to in priority, can be obtained.

Accordingly, the output answer data generated based on an appropriate information source can be obtained for the question data. This prevents the output answer data having inappropriate contents from being output.

### Fifth Example

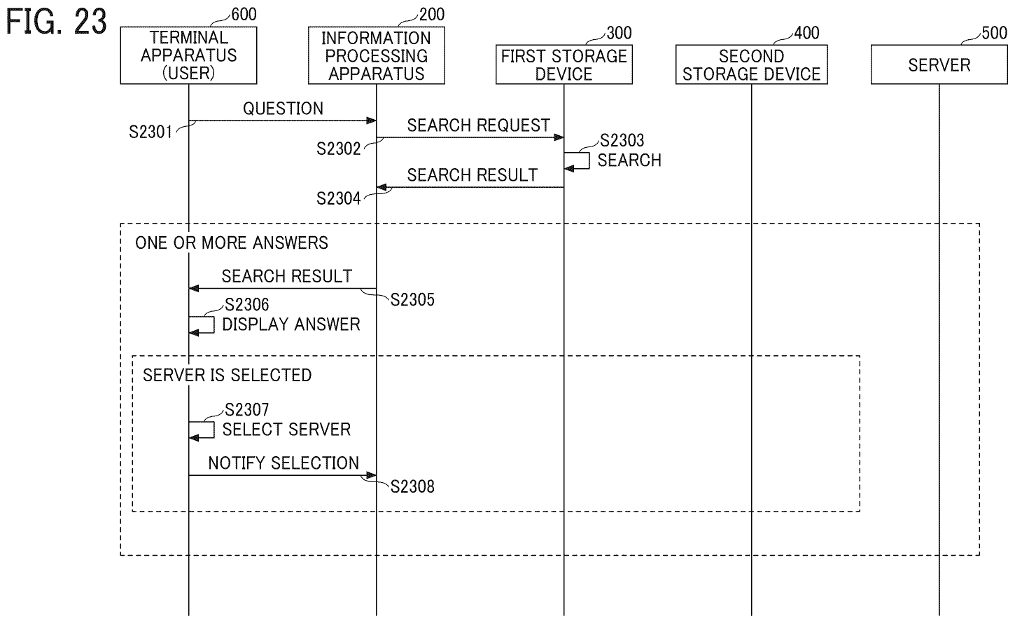

Another example operation performed by the chat system 100 is described below with reference to FIGS. 23 to 25. The following example is different from the example of FIG. 9 in that the question and answer DB 320 is searched before requesting the server 500 to provide an answer. In the following description of the fifth example, differences from the first example are described. The same reference numerals are given to the same or corresponding functions or configurations as those of the first example, and redundant descriptions thereof are omitted or simplified appropriately.

FIG. 23 is a sequence diagram illustrating the example operation performed by the chat system 100.

In the chat system 100, when the information processing apparatus 200 receives input of question data from the terminal apparatus 600 at S2301, at S2302, the search request unit 252 transmits a search request to the first storage device 300.

The search request transmitted to the first storage device 300 includes the tenant ID and the question data, and requests to search the question and answer DB 320 that stores the question and answer information associated with the tenant ID.

When the first storage device 300 receives the search request, at S2303, the search unit 330 searches the question and answer DB 320 for the question and answer information associated with the tenant ID. At S2304, the search unit 330 transmits the registered answer data, which is searched, to the information processing apparatus 200. Specifically, the search unit 330 searches for the question and answer information associated with the tenant ID, and extracts, from the question and answer information, the registered answer data associated with the question indicated by the question data as a search result.

When no registered answer data is extracted, that is, when the question corresponding to the question data input at S2301 is not stored in the question and answer DB 320, the information processing apparatus 200 proceeds to S902 of FIG. 9 and performs S902 and the subsequent steps.

When one or more records of registered answer data are extracted, the information processing apparatus 200 performs S2305 and the subsequent steps, which will be described below.

At S2305, the information processing apparatus 200 transmits the registered answer data acquired from the first storage device 300 to the terminal apparatus 600. At S2306, the display control unit 650 of the terminal apparatus 600 displays the registered answer data obtained from the information processing apparatus 200 as an answer to the question data.

In this case, the registered answer data displayed at the terminal apparatus 600 is extracted from the question and answer information stored in the question and answer DB 320.

Further, when the terminal apparatus 600 is instructed to acquire an answer using the large-scale language model 511, S2307 and the subsequent steps may be performed.

At S2307, the input receiving unit 640 of the terminal apparatus 600 receives an operation of instructing to acquire an answer from the server 500 on the screen displayed at S2306. At S2308, the terminal apparatus 600 transmits a notification indicating that the instruction for acquiring the answer from the server 500 is received to the information processing apparatus 200.

When the information processing apparatus 200 is notified of the instruction to acquire the answer from the server 500, at S2308, the information processing apparatus performs 200 S902 and the subsequent steps of FIG. 9.

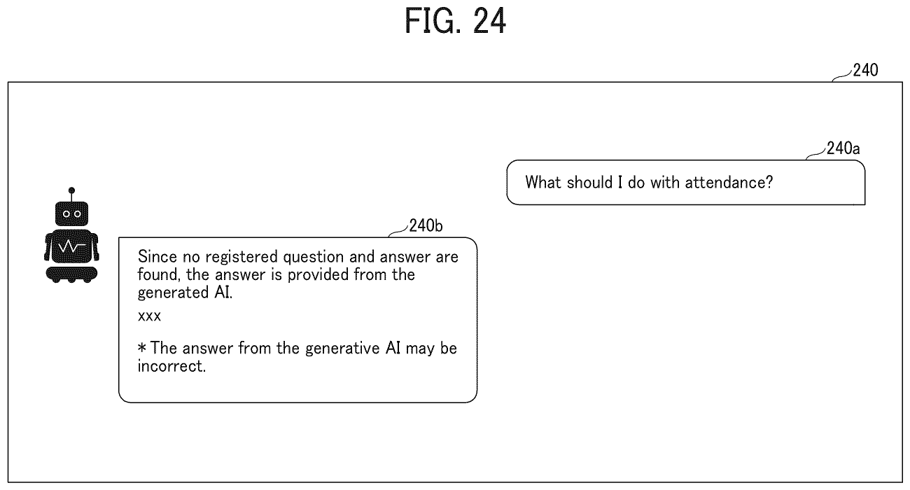

Example screens of the terminal apparatus 600 are described below with reference to FIGS. 24 to 26.

FIG. 24 is a first diagram illustrating an example screen displayed by the terminal apparatus 600. FIG. 24 illustrates a screen 240, which is one example of a screen displayed on the terminal apparatus 600, when no registered answer data is extracted at S2304 of FIG. 23.

The screen 240 may be displayed on the terminal apparatus 600 at S915 of FIG. 9, for example, when the process of S902 and the subsequent steps of FIG. 9 are performed after the processes up to S2304 of FIG. 23 are performed in the chat system 100.

The screen 240 includes display areas 240a and 240b. The display area 240a displays question data input by the user of the terminal apparatus 600. The display area 240b displays the output answer data output from the chat system 100.

In the example of FIG. 24, the display area 240b displays text data indicating that the answer corresponding to the question indicated by the question data displayed in the display area 240a is not stored in the question and answer DB 320. The display area 240b displays text data indicating that the answer acquired from the server 500 having the large-scale language model 511 is to be output with respect to the question data.

As described above, even when the registered answer data corresponding to the question indicated by the question data is not stored in the question and answer DB 320, the output answer data generated by the server 500 can be presented to the user.

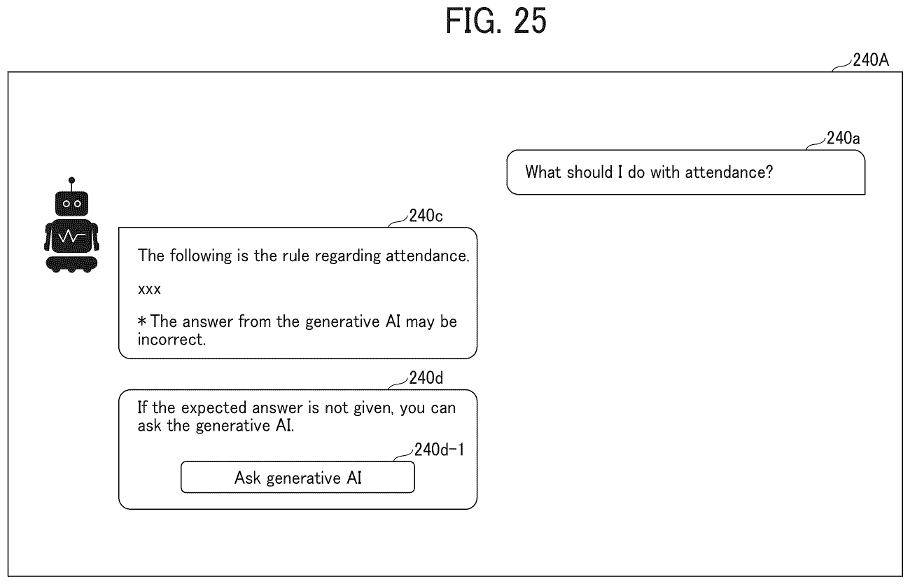

FIG. 25 is a second diagram illustrating an example screen displayed by the terminal apparatus 600. FIG. 25 illustrates a screen 240A, which is one example of a screen displayed on the terminal apparatus 600 at S2306, when one registered answer data is acquired at S2304 of FIG. 23.

The screen 240 includes display areas 240a, 240c, and 240d. The display area 240c displays the registered answer data included in the question and answer information stored in the question and answer DB 320. In other words, the display area 240c includes the registered answer data obtained at S2304 as a search result.

The display area 240d displays text data indicating that the output answer data generated by the large-scale language model 511 of the server 500 can be acquired, and an operation button 240d-1 for instructing acquisition of the answer generated by the large-scale language model 511 (generation AI) of the server 500.

When the operation button 240d-1 displayed in the display area 240d is operated, the processes of S2307 and the subsequent steps in FIG. 23 may be performed.

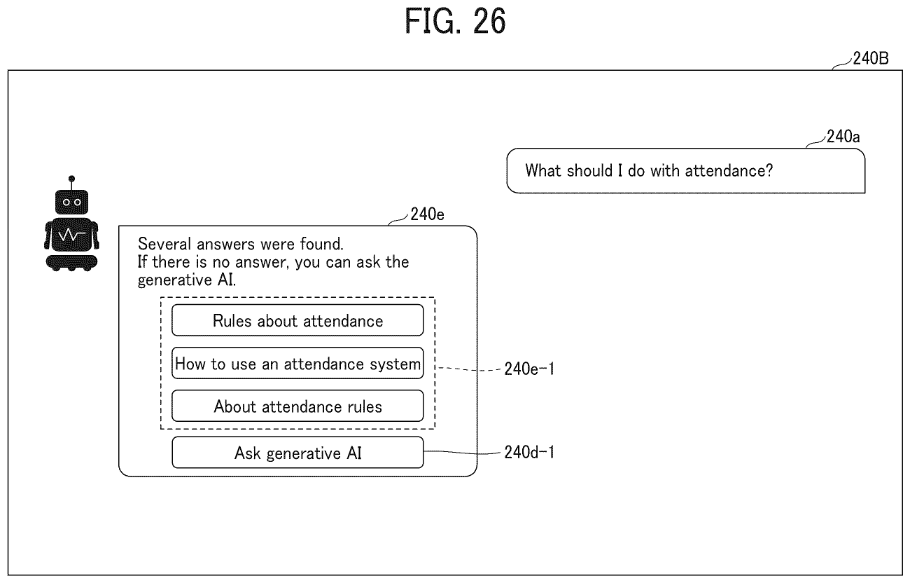

FIG. 26 is a third diagram illustrating an example screen displayed by the terminal apparatus 600. FIG. 26 illustrates a screen 240B, which is an example of a screen displayed at the terminal apparatus 600 at S2306, when a plurality of records of registered answer data are acquired at S2304 of FIG. 23.

The screen 240B includes display areas 240a and 240e. The display area 240c includes the records of registered answer data 240e-1 included in the question and answer information stored in the question and answer DB 320 and an operation button 240d-1.

In other words, the display area 240e displays, as the registered answer data 240c-1, the plurality of records of registered answer data obtained as a search result at S2304.

In this example, when the operation button 240d-1 is operated on the screen 250B, the processes of S2307 and the subsequent steps in FIG. 23 may be performed.

With the display of the operation button 240d-1, the server 500 can generate output answer data in response to a user's request.

Before the server 500 generates an answer, the question and answer DB 320 is searched, and the registered answer data associated with the registered question data corresponding to the question indicated by the question data is output. In this way, the registered answer data is obtained as an appropriate answer to the question indicated by the question data. The question and answer DB 320 and the server 500 operate in cooperation to output the answer to the question, thus, reducing the frequency in outputting an erroneous answer or an inappropriate answer.

### Sixth Example

Another example operation performed by the chat system 100 is described below with reference to FIGS. 26 to 30. The following example is different from the example of FIG. 9 in that a selection can be made to determine whether or not information other than in-company information is used as an information source. In the following description of the sixth example, differences from the first example are described. The same reference numerals are given to the same or corresponding functions or configurations as those of the first example, and redundant descriptions thereof are omitted or simplified appropriately.

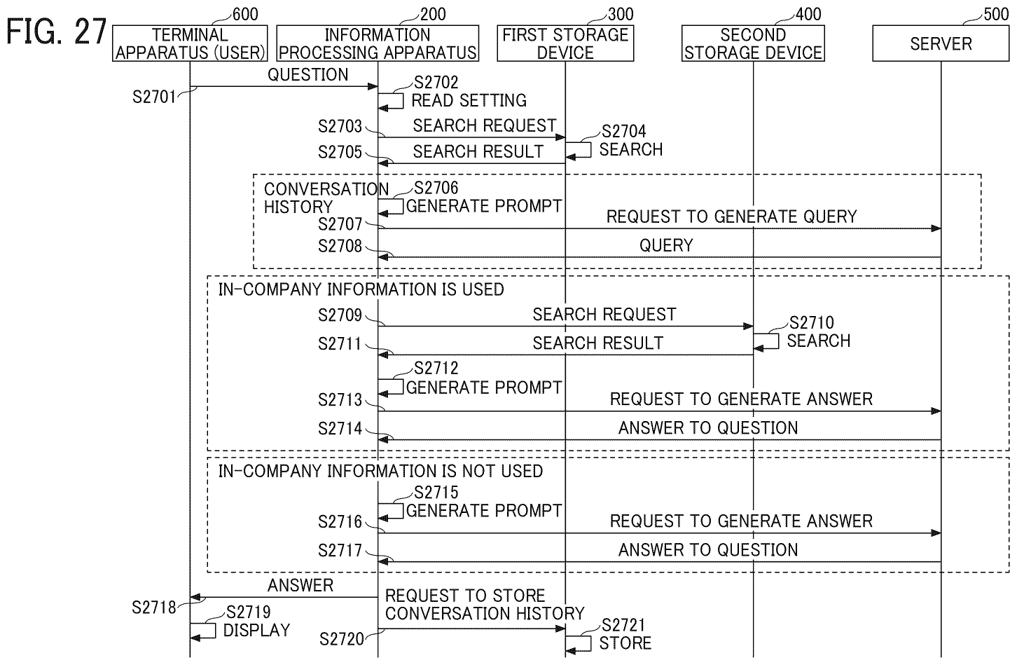

FIG. 27 is a sequence diagram illustrating the example operation performed by the chat system 100.

When the information processing apparatus 200 receives the input of the question data from the terminal apparatus 600 at S2701, at S2702, the prompt generating unit 255 refers to the setting information regarding the information source that can be referred to by the large-scale language model 511.

Specifically, the prompt generating unit 255 refers to the setting information indicating whether the information source for the large-scale language model 511 is set to the in-company information and the disclosed information on the Internet or only to the disclosed information on the Internet.

The setting information may be input by the user of the terminal apparatus 600. For example, the setting information may be input when the question data is input at the terminal apparatus 600, and may be transmitted to the information processing apparatus 200 with the question data.

The setting information may be previously stored in the information processing apparatus 200 by the user of the terminal apparatus 700, such as the administrator managing the in-company information. Further, the setting information may be set such that only the in-company information is treated as the information source that can be referred to by the large-scale language model 511. In this case, the information processing apparatus 200 may perform the processes of S902 and the subsequent steps in FIG. 9 after step S2702.

The process of referring to the setting information may be performed at a time different from S2702. In particular, the time when the setting information is referred to may set to be before S2701.

When the information processing apparatus 200 determines that the information source that can be referred to by the large-scale language model 511 are set to the in-company information and the disclosed information on the Internet, the operation proceeds to S2703. The chat system 100 performs the processes from S2703 to S2714 to acquire the output answer data to be output to the terminal apparatus 600.

The processes from S2703 to S2714 in FIG. 27 are the same as the processes from S902 to S913 in FIG. 9, except that the prompt generated at S2712 differs from the prompt generated at S911 of FIG. 9, and the description thereof is omitted. The prompt generated at S2712 will be described in detail below.

When the information processing apparatus 200 determines that the information source that can be referred to by the large-scale language model 511 is only the disclosed information on the Internet, the operation proceeds to S2715. The chat system 100 performs the processes from S2715 to S2717 to acquire the output answer data from the server 500.

The processes from S2715 to S2717 in FIG. 27 are the same as the processes from S911 to S913 in FIG. 9, except that the prompt generated at S2715 differs from the prompt generated at S911 of FIG. 9, and the description thereof is omitted. The prompt generated at S2715 will be described in detail below.

When the information processing apparatus 200 acquires the output answer data from the server 500, the operation proceeds to S2718. The chat system 100 performs the processes from S2718 to S2721.

Since the processes from S2718 to S2721 of FIG. 27 is the same as the processes from S914 to S917 of FIG. 9, the description thereof is omitted.

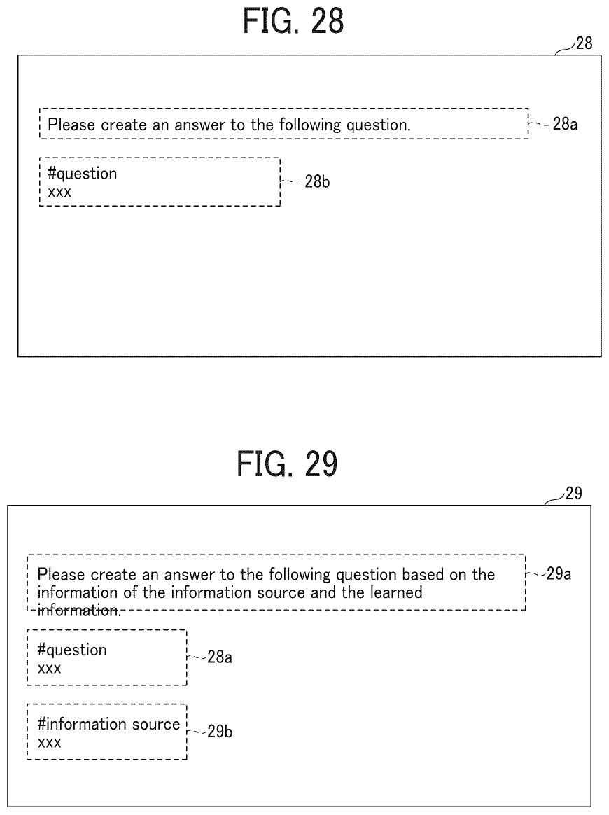

An example prompt transmitted from the information processing apparatus 200 to the server 500 is described with reference to FIGS. 28 to 30.

FIG. 28 is a diagram illustrating an example prompt. FIG. 28 illustrates a prompt 28, which is an example of the prompt generated by the prompt generation unit 255 at S2712 of FIG. 27.

The prompt 28 includes text data 28a and text data 28b. The text data 28a is text data for requesting generation of output answer data to the question indicated by the question data. The text data 28b is text data indicating the question data input at S2701.

By inputting the prompt 28 to the large-scale language model 511, the output answer data can be obtained by referring to the information on the Internet that the large-scale language model 511 has used for learning.

FIG. 29 is a diagram illustrating an example prompt. FIG. 29 illustrates a prompt 29, which is an example of the prompt generated by the prompt generation unit 255 at S2712 of FIG. 27.

The prompt 29 includes text data 29a, text data 28a, and text data 29b. The text data 29a is text data for requesting generation of output answer data based on the in-company information indicated by the text data 29b and the disclosed information on the Internet used for learning by the large-scale language model 511.

The text data 29b indicates the in-company information acquired by the information processing apparatus 200 at S2711 of FIG. 27.

By inputting the prompt 29 to the large-scale language model 511, an answer generated based on the in-company information and the information disclosed to the public can be presented to the user.

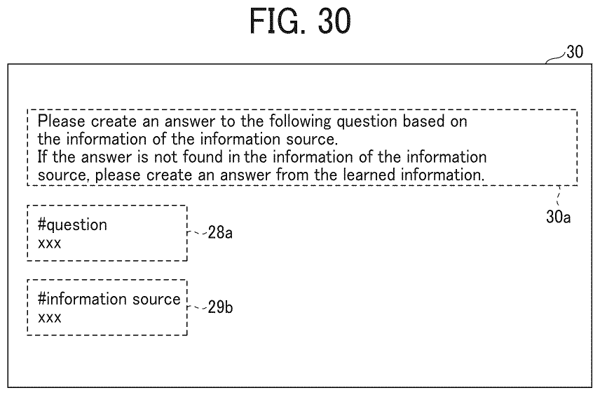

FIG. 30 is a diagram illustrating an example prompt. FIG. 30 illustrates a prompt 30, which is an example of the prompt generated by the prompt generation unit 255 at S2712 of FIG. 27.

The prompt 30 includes text data 30a, text data 28a, and text data 29b. The text data 30a is text data for requesting generation of output answer data based on the in-company information indicated by the text data 29b. The text data 30a further requests, when there is no answer in the in-company information, generation of output answer data based on the information on the Internet that the large-scale language model 511 has learned.

By inputting the prompt 30 to the large-scale language model 511, even when the in-company information as the information source does not include an answer, an answer generated based on the information disclosed to the public can be presented to the user.

In this way, it is possible to select whether the information source used for generating the output answer data is limited to the in-company information and the information opened to the public or limited to only the information opened to the public. When the user of the chat system 100 desires a general answer, the user may use only the information open to the public as an information source for generating output answer data. When the user of the chat system 100 desires an answer based on the in-company information, the information source for generating output answer data may be set to the in-company information and the information opened to the public.

Accordingly, an answer can be presented to the user, which is generated based on an information source desired by the user.

### Seventh Example

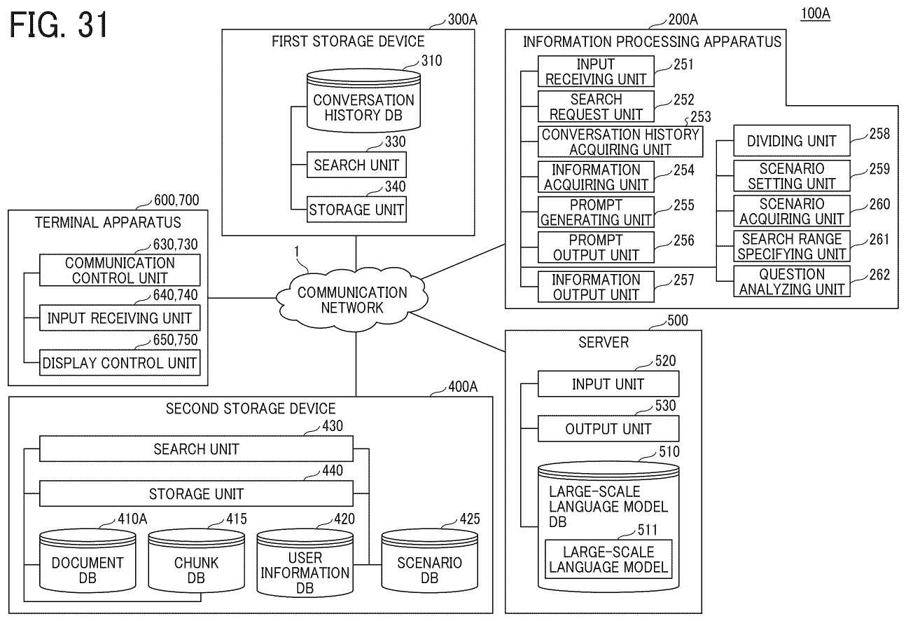

Another example operation performed by a chat system 100A is described below with reference to FIGS. 31 to 41. The following example is different from the example of FIG. 9 in that a range to be searched is specified in the in-company information in accordance with the user's operation or the contents of the question. In the following description, differences from the first example are described. The same reference numerals are given to the same or corresponding functions or configurations as those of the first example, and redundant descriptions thereof are omitted or simplified appropriately.

An overview of operation is described below. In this example, the large-scale language model 511 generates an answer using a part of the in-company information, which is desired by the user who makes a question, as an information source. More specifically, the terminal apparatus 700 requests the user who asks the question to specify a range of the in-company information to be the information source for the answer. The result of searching the in-company information in the designated range is included in the prompt for requesting the large-scale language model 511 to generate the answer.

When the user who asks the question does not specify the range of the in-company information, the range of the in-company information to be the information source of the answer is specified according to the content of the question. In this example, the result of searching for the in-company information in the specified range is included in a prompt for requesting the large-scale language model 511 to generate an answer.

In this way, an answer is generated based on a part of the in-company information that is desired by the user as an information source, and presented to the user who asked the question.

FIG. 31 is a diagram illustrating functional configurations of the apparatuses or devices included in the chat system 100A. Compared to the chat system 100 of FIG. 8, the chat system 100A includes a second storage device 400A in alternative to the second storage device 400, a first storage device 300A in alternative to the first storage device 300, and an information processing apparatus 200A in alternative to the information processing apparatus 200.

The second storage device 400A in the chat system 100A is described.

The second storage device 400A includes a document DB 410A, a chunk DB 415, a user information DB 420, and a scenario DB 425. The document DB 410A has a plurality of storage areas, each of which stores specific in-company information according to the setting of the administrator of the chat system 100A. In the following description, each of the plurality of storage areas in the document DB 410A is referred to as a folder. The chunk DB 415 stores chunks of the in-company information.

The scenario DB 425 stores information for specifying a search range of the in-company information stored in the second storage device 400A. In the following description, the information stored in the scenario DB 425 is referred to as scenario information. The scenario information may be previously set by an administrator of the chat system 100A and stored in the scenario DB 425.

The document DB 410A, the chunk DB 415, and the scenario DB 425 will be described in detail below.

The functions of the information processing apparatus 200A is described below. The information processing apparatus 200A includes the input receiving unit 251, the search request unit 252, the conversation history acquiring unit 253, the information acquiring unit 254, the prompt generating unit 255, the prompt output unit 256, the information output unit 257, a dividing unit 258, a scenario setting unit 259, a scenario acquiring unit 260, a search range specifying unit 261, and a question analyzing unit 262.

The dividing unit 258 divides the in-company information stored in the document DB 410A into a plurality of chunks of data. The scenario setting unit 259 sets the scenario information. The scenario setting unit 259 generates the scenario information in response to an operation at the terminal apparatus 700, and stores the scenario information in the scenario DB 425 of the second storage device 400A.

The scenario acquiring unit 260 acquires the scenario information stored in the scenario DB 425 of the second storage device 400A in response to an operation on the terminal apparatus 600. The search range specifying unit 261 specifies a search range of the chunk stored in the chunk DB 415 based on the scenario information acquired by the scenario acquiring unit 260. The question analyzing unit 262 analyzes question data input from the terminal apparatus 600. Specifically, the question analyzing unit 262 performs morphological analysis on the question data, or acquires the attributes of the user associated with the terminal apparatus 600 to which the question data is input, to specify the scenario information to be referred to.

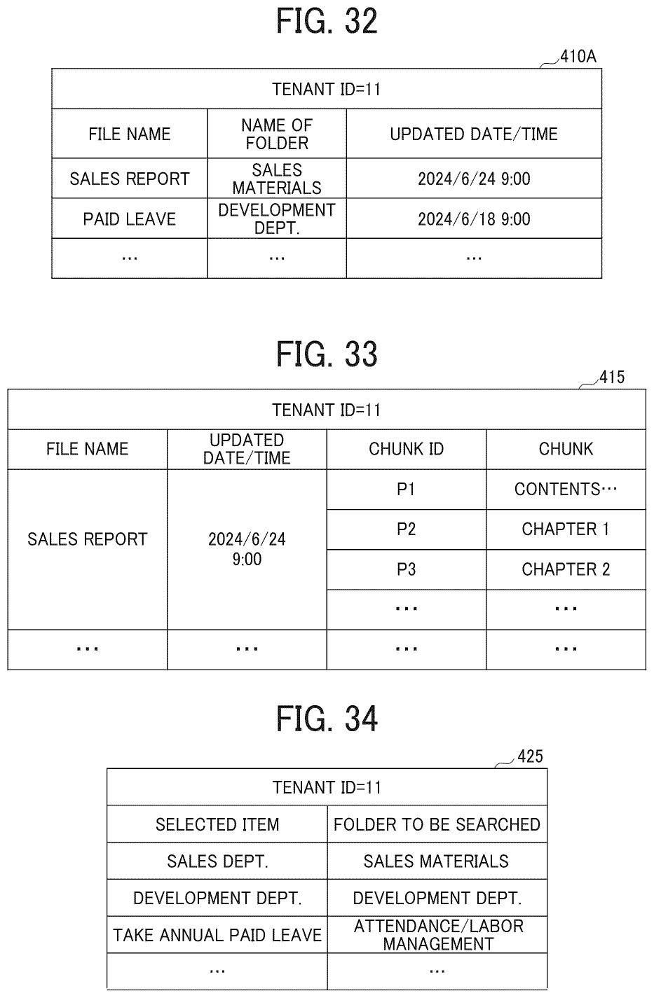

The document DB 410A, the chunk DB 415, and the scenario DB 425 included in the second storage device 400A are described below with reference to FIGS. 32 to 34.

FIG. 32 is a table illustrating the document DB 410A. The document DB 410A includes a plurality of folders, and stores specific in-company information in each folder. The folder may be created in advance by an administrator of the chat system 100A.

The document DB 410A may store, for example, the file name of the in-company information to be stored, the name of the folder in which the in-company information is stored, the update date and time of the in-company information, in association with the in-company information.

In the example of FIG. 32, the information indicates that the in-company information having the file name “sales report” is stored in the “sales materials” folder at 9:00 AM on Jun. 24, 2024. Further, in the example of FIG. 32, the information indicates that the in-company information having the file name “paid leave” is stored in the “development department” folder at 9:00 AM on Jun. 18, 2024.

The folder created in the document DB 410A may be created, for example, for each business content in the tenant or for each department in the tenant. The folder in the document DB 410A may be generated by the administrator of the tenant that uses the chat system 100.

FIG. 33 is a table illustrating the chunk DB 415. The table of FIG. 33 stores the file name of the in-company information, which is an example of information identifying the in-company information, the update date and time of the in-company information, the chunk ID for identifying each chunk data, and each chunk data in association.

In the example of FIG. 33, one page of the in-company information contained in the in-company document “sales report” is set as chunk data, and a page number is set as a chunk ID for identifying the chunk data.

The chunk data does not have to correspond to one page of the in-company document, and may correspond to, for example, one paragraph or one chapter of the in-company document.

FIG. 34 is a table illustrating the scenario DB 425. The scenario DB 425 may store the scenario by each tenant.

The scenario information stored in the scenario DB 425 includes a tenant ID, a specified item, and a folder to be searched in association, as data items to be managed. The value of the “specified item” indicates an item for causing the user to specify a range of the in-company information to be the information source of the answer. In other words, the value of the “specified item” is an item used for classifying the in-company information. The in-company information is classified into chunks according to each specified item and stored in the document DB 410A.

The terminal apparatus 600 displays a list of items indicated by the “specified item” as options to be selected when specifying the range of the in-company information. The value of the “folder to be searched” indicates a folder name associated with the specified item.

In the example of FIG. 34, the specified items include, for example, “sales department”, “development department”, and “take annual paid leave”, which are displayed at the terminal apparatus 600. Further, in the example of FIG. 34, the specified item “sales department” is associated with the “sales materials” folder, the specified item “development department” is associated with the “development department” folder, and the specified item “take paid leave” is associated with the “attendance/labor management” folder.

Accordingly, in the example of FIG. 34, the terminal apparatus 600 displays operation buttons such as “sales department”, “development department”, and “take paid leave”, as options to be selected when selecting the specified item. When the operation button indicating “sales department” is selected from the operation buttons displayed as the options, the in-company information stored in the “sales department” folder in the document DB 410A is specified as the information source of the answer.

In the example of FIG. 34, the specified item is set separately from the folder name in the document DB 410A, but the present disclosure is not limited to this example. For example, the folder name in the document DB 410A may be used as the specified item.

In such case, the terminal apparatus 600 may display a list of folder names created in the document DB 410A as a list of items for specifying the range of the in-company information to be used as the information source.

In the example of FIG. 34, the scenario information is information associating the specified item and the folder to be searched, but the present disclosure is not limited to this example. For example, the scenario information may include operation information for specifying an operation of the chat system 100A for each specified item. The operation information may be, for example, information indicating an operation of the chat system 100A when information obtained from a question input from the terminal apparatus 600 is insufficient. The operation information may be information indicating an operation of the chat system 100A when there are a plurality of folders associated with the specified item.

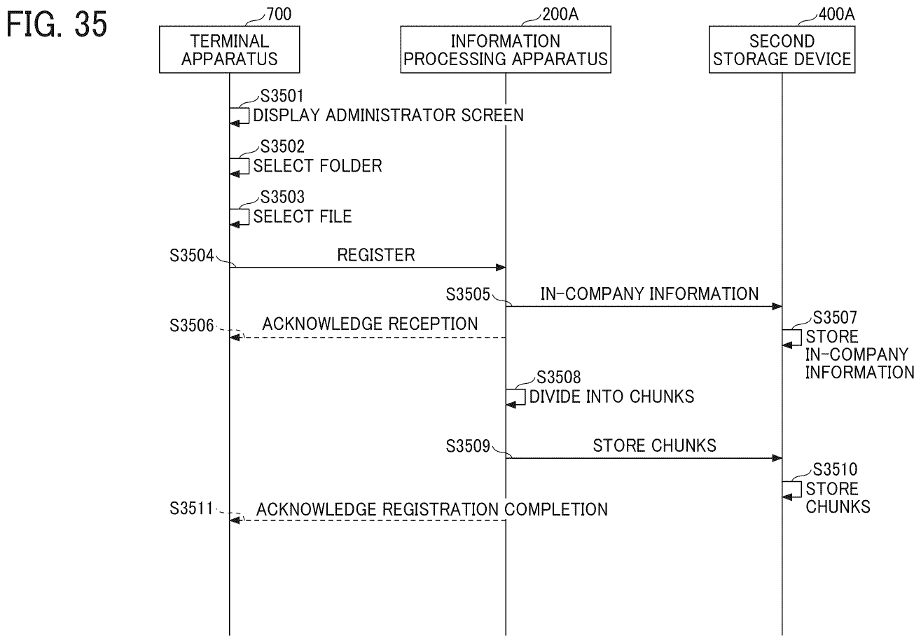

An example operation performed by the chat system 100A when storing the in-company information in the second storage device 400A is described below with reference to FIG. 35. FIG. 35 is a first sequence diagram illustrating the example operation performed by the chat system 100A.

In the chat system 100, at S3501, the display control unit 750 of the terminal apparatus 700 displays an administrator screen for the administrator. At S3502, the input receiving unit 740 of the terminal apparatus 700 receives an operation for selecting a folder as a storage destination of the in-company information. At S3503, the input receiving unit 740 of the terminal apparatus 700 receives a selection of the in-company information to be stored in the folder. At S3504, the communication control unit 730 of the terminal apparatus 700 transmits (uploads) the selected in-company information to the information processing apparatus 200.

When the input receiving unit 251 receives the in-company information, at S3505, the information output unit 257 of the information processing apparatus 200A transmits the received in-company information to the second storage device 400A. At S3506, the information output unit 257 further transmits a reception notification indicating that the in-company information has been received to the terminal apparatus 700. At S3507, the storage unit 440 of the second storage device 400A stores the in-company information in the selected folder in the document DB 410A.

At S3508, the dividing unit 258 of the information processing apparatus 200A divides the in-company information into chunk data. At S3509, the information output unit 257 of the information processing apparatus 200A transmits the divided chunk data to the second storage device 400A.

At S3510, the storage unit 440 of the second storage device 400A stores the chunk data received from the information processing apparatus 200A in the chunk DB 415 with information for specifying the in-company information including the chunk data.

At S3511, the information output unit 257 of the information processing apparatus 200A transmits a completion notification indicating that the registration of the in-company information has been completed to the terminal apparatus 700.

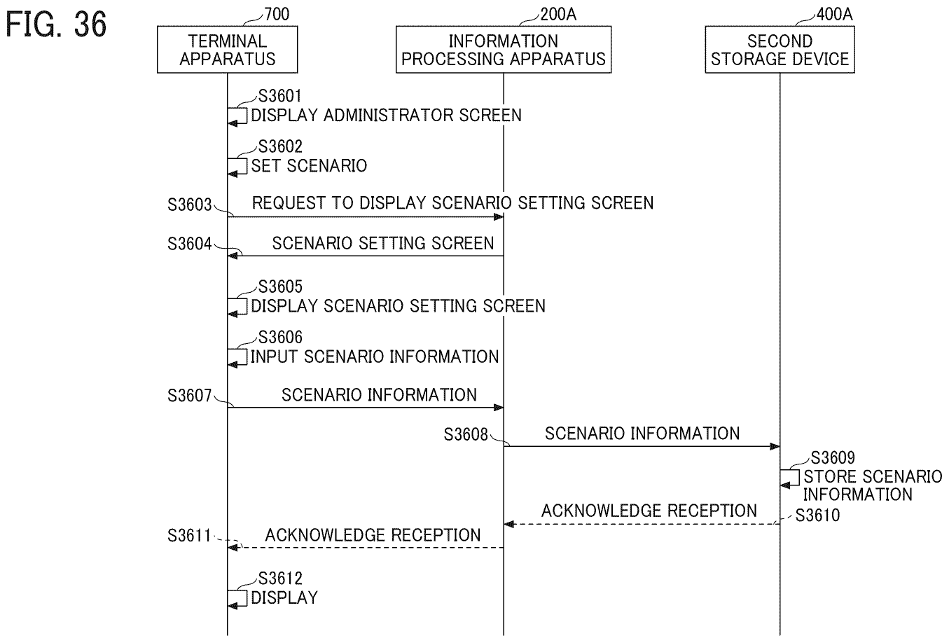

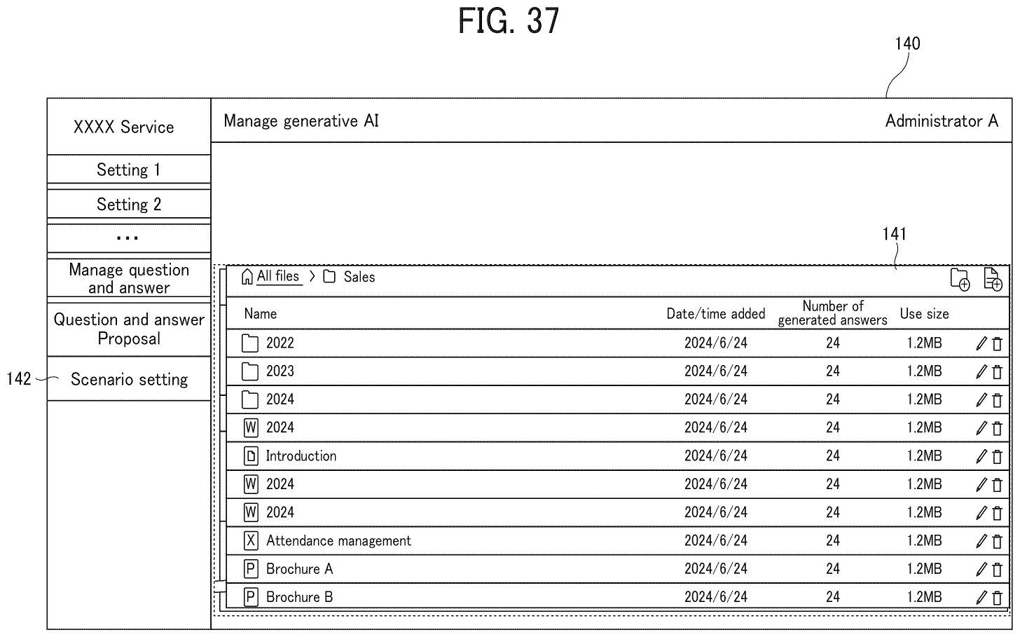

An example operation performed by the chat system 100A when storing the scenario information in the scenario DB 425 is described below with reference to FIG. 36. FIG. 36 is a second sequence diagram illustrating the example operation performed by the chat system 100A.

In the chat system 100A, at S3601, the display control unit 750 of the terminal apparatus 700 displays an administrator screen for the administrator. At S3602, the input receiving unit 740 of the terminal apparatus 700 receives an operation for setting the scenario information. At S3603, the communication control unit 730 of the terminal apparatus 700 transmits a request for displaying a scenario setting screen to the information processing apparatus 200A.

When the information processing apparatus 200A receives the displaying request, at S3604, the scenario setting unit 259 outputs an instruction to display the scenario setting screen to the terminal apparatus 700 through the information output unit 257.

At S3605, the terminal apparatus 700 receives the displaying instruction and causes the display control unit 750 to display the scenario setting screen. At S3606, the input receiving unit 740 of the terminal apparatus 700 receives an input of the scenario information.

For example, when a specified item is input and a folder name to be associated with the specified item is selected on the scenario setting screen, the terminal apparatus 700 may associate the specified item, the selected folder name, and the tenant ID of the tenant to which the user of the terminal apparatus 700 belongs with one another and set the associated information as the scenario information.

The specified item may be newly entered by the user of the terminal apparatus 700 or may be selected from the scenario information stored in the scenario DB 425.

At S3607, the communication control unit 730 of the terminal apparatus 700 transmits the input scenario information to the information processing apparatus 200A.

When the scenario setting unit 259 of the information processing apparatus 200A receives the scenario information from the terminal apparatus 700, at S3608, the information output unit 257 outputs the received scenario information to the second storage device 400A.

At S3609, the second storage device 400A stores the scenario information received from the information processing apparatus 200A in the scenario DB 425. At S3610, the second storage device 400A transmits a notification indicating completion of storage to the information processing apparatus 200A. In response to the notification, at S3611, the information output unit 257 of the information processing apparatus 200A transmits a notification indicating that the reception of the scenario information is completed to the terminal apparatus 700. At S3612, the display control unit 750 of the terminal apparatus 700 displays the notification received from the information processing apparatus 200A.

By setting the scenario information as described above, a list of specified items to be displayed on the terminal apparatus 600 can be created.

Example screen of the terminal apparatus 700 is described below with reference to FIG. 37. FIG. 37 is a first diagram illustrating an example screen displayed by the terminal apparatus 700. FIG. 37 illustrates a screen 140, which is an example of an administrator screen displayed on the terminal apparatus 700 at S3501 of FIGS. 35 and S3601 of FIG. 36.

The screen 140 includes a display area 141 and an operation button 142. The display area 141 displays a list of in-company information stored in a particular folder in the document DB 410A. In the example of FIG. 14, a list of in-company information stored in the “sales department” folder is displayed.

The operation button 142 is an operation button for displaying a scenario setting screen. In this example, when the operation button 142 is operated on the screen 140, the terminal apparatus 700 transmits a request for displaying a scenario setting screen to the information processing apparatus 200A, and the screen 140 is switched to the scenario setting screen.

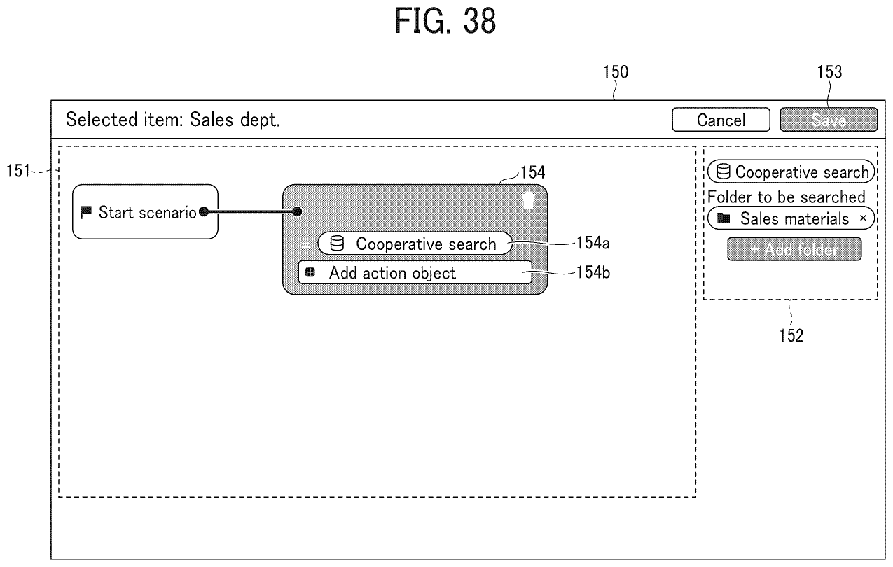

FIG. 38 is a second diagram illustrating an example screen displayed by the terminal apparatus 700. FIG. 38 illustrates a screen 150, which is an example of the scenario setting screen displayed on the terminal apparatus 700 at S3605 of FIG. 36. The screen 150 is an example of a scenario setting screen for setting scenario information of the specified item “sales department”.

The screen 150 includes display areas 151 and 152 and an operation button 153. The display area 151 displays a display area 154 for selecting a target associated with the specified item. The display area 154 includes operation buttons 154a and 154b.

The target associated with the specified item may be a folder to be searched or may be operation information associated with each specified item. The operation button 154a is an operation button for selecting a folder to be searched as a target to be associated with the specified item. The operation button 154b is an operation button for newly adding a target associated with the specified item.

In FIG. 38, the operation button 154a is selected in the display area 154. The display area 152 displays a selection field of a folder to be associated with the specified item “sales department”. Specifically, in the display area 152, the “sales material” folder is associated with the specified item “sales department”. The operation button 153 is an operation button for storing, in the second storage device 400A, the scenario information including the specified item and the folder name that are associated in the display area 152.

In this example, when the operation button 153 is operated after the specified item is associated with the folder to be searched or the operation information on the screen 150, the terminal apparatus 700 transmits the scenario information to the information processing apparatus 200A.

Further, in this example, the administrator of the chat system 100A may set the operation of the chat system 100A when starting to provide the service by the chat system 100A.

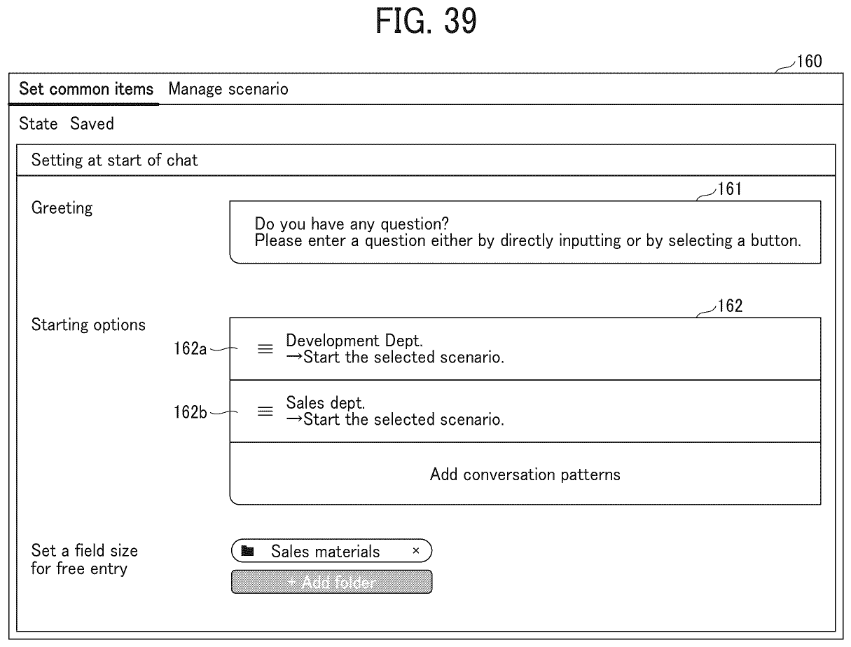

FIG. 39 is a third diagram illustrating an example screen displayed by the terminal apparatus 600. FIG. 39 illustrates a screen 160, which is an example of a screen for setting the operation of the chat system 100A when the chat system 100A starts providing a service.

The screen 160 includes setting fields 161 and 162. The setting field 161 is a field for setting a message to be displayed on the terminal apparatus 600 when the chat system 100A starts providing the service. In the example of FIG. 39, the message “Do you have any question? Please enter a question either by directly inputting or by selecting a button.” is set to be displayed.

The setting field 162 indicates that, when a particular specified item is selected from a list of the specified items displayed on the terminal apparatus 600 at a start of providing the service by the chat system 100A, particular processing according to the scenario information associated with the particular specified item is performed.

In this example, the administrator of the chat system 100A can set the operation of the chat system 100A when the chat system 100A starts providing the service.

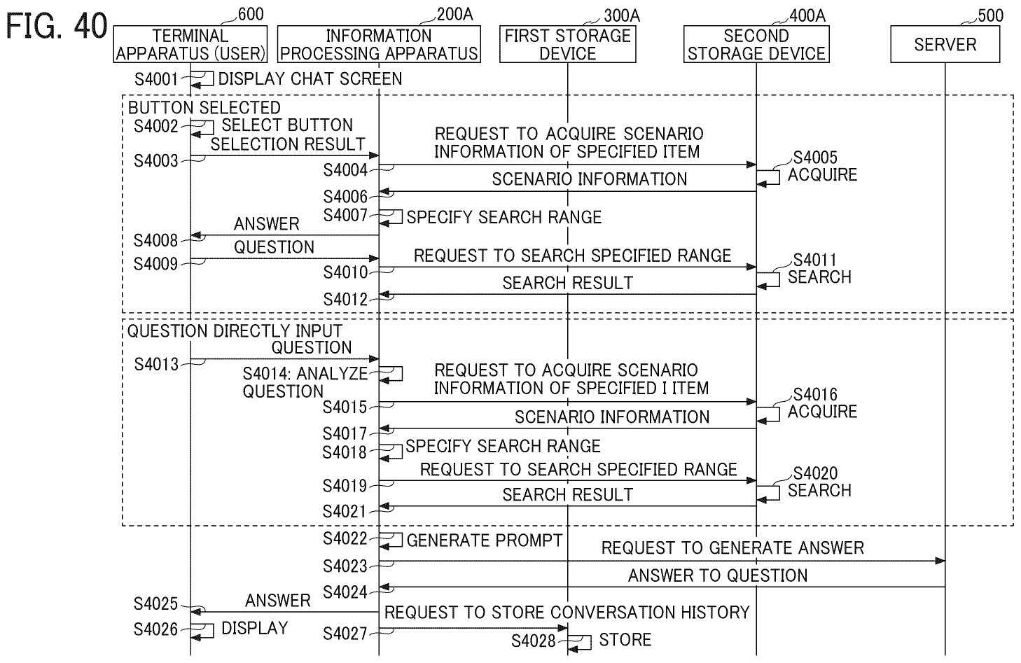

An example operation of the chat system 100A performed when a question is asked by the user of the terminal apparatus 600 is described below with reference to FIG. 40. FIG. 40 is a third sequence diagram illustrating the example operation performed by the chat system 100A.

At S4001, in the chat system 100A, the display control unit 650 of the terminal apparatus 600 displays a chart screen. The chat screen includes a list of specified items as a list of the operation buttons for display to the user of the terminal apparatus 600.

The following processes from S4002 to S4012 indicate the operation of the chat system 100A, when the operation button is selected on the chat screen displayed on the terminal apparatus 600 at S4001.

At S4002, the terminal apparatus 600 receives a selection of the operation button displayed on the chat screen. At S4003, the communication control unit 630 transmits information for identifying the selected operation button to the information processing apparatus 200A. In other words, in response to receiving the selection of the specified item from the list of the specified items, the terminal apparatus 600 transmits a notification indicating the selected specified item to the information processing apparatus 200A.

When the information processing apparatus 200A receives the information identifying the selected operation button (the selected specified item), at S4004, the scenario acquiring unit 260 transmits a request for acquiring scenario information corresponding to the specified item to the second storage device 400A. When the second storage device 400A receives the request for acquiring, at S4005, the second storage device 400A searches the scenario DB 425 using the specified item to obtain the scenario information corresponding to the specified item. At S4006, the second storage device 400A transmits the acquired scenario information to the information processing apparatus 200A.

When the information processing apparatus 200A acquires the scenario information, at S4007, the search range specifying unit 261 specifies the in-company information in the folder to be searched, which is included in the scenario information, as a search range. At S4008, the information output unit 257 of the information processing apparatus 200A outputs a message indicating that an answer based on the in-company information within the search range is to be output to the terminal apparatus 600.

When the terminal apparatus 600 receives an input of question data on the chat screen, at S4009, the communication control unit 630 transmits the question data to the information processing apparatus 200A.

When the information processing apparatus 200A receives the input of the question data by the input receiving unit 251, at S4010, the search request unit 252 transmits a request for searching the search range specified at S4007 to the second storage device 400A. The request for searching, which is transmitted to the second storage device 400A, may be, for example, a result of morphological analysis performed by the question analyzing unit 262 on the question data input at S4009.

When the second storage device 400A receives the request for searching, at S4011, the search unit 430 searches for chunk data within the search range specified at S4007, from among the chunk data stored in the chunk DB 415. At S4012, the second storage device 400A transmits the search result to the information processing apparatus 200A, and the operation proceeds to S4022 described below.

The following processes from S4013 to S4018 indicate the operation of the chat system 100A, when the question data is directly input without selecting the operation button on the chat screen displayed on the terminal apparatus 600 at S4001.

When the question data is input, at S4013, the communication control unit 630 of the terminal apparatus 600 transmits the question data to the information processing apparatus 200A. When the information processing apparatus 200A receives the input of the question data by the input receiving unit 251, at S4014, the question analyzing unit 262 analyzes the question data and identified the specified item. In other words, the question analyzing unit 262 analyzes the question data and acquires the scenario information to be referred to based on the analysis result.

The processes performed by the question analyzing unit 262 is described below. For example, the question analyzing unit 262 may refer to the scenario DB 425 of the second storage device 400A, and may identify the specified item based on the contents of the question data.

The question analyzing unit 262 may acquire the attributes of the user by referring to the user information of the user of the terminal apparatus 600, and identify the specified item based on the attributes of the user. The attributes of the user include, for example, a department to which the user belongs. In this case, it is assumed that the information processing apparatus 200A previously acquires the user ID of the user of the terminal apparatus 600, and the tenant ID of the tenant to which the user belongs. The question analyzing unit 262 may refer to the scenario DB 425 of the second storage device 400A, and identify the specified item based on the attributes of the user of the terminal apparatus 600.

At S4015, the scenario acquiring unit 260 of the information processing apparatus 200A transmits a request for acquiring the scenario information of the specified item, which is identified, to the second storage device 400A.

Since the processes from S4015 to S4018 of FIG. 40 are the same as the processes from S4004 to S4007 of FIG. 40, the description thereof is omitted. Further, since the processes from S4019 to S4021 of FIG. 40 are the same as the processes from S4010 to S4012 of FIG. 40, the description thereof is omitted. The request for searching, which is transmitted to the second storage device 400A, may be, for example, a result of morphological analysis performed by the question analyzing unit 262 on the question data input at S4013.

In this example, even when the user of the terminal apparatus 600 does not select a specified item, the specified item can be automatically identified from the contents of the question data or the attributes of the user. This increases the probability that the answer data is output, which is based on the information source desired by the user.

At S4022, the prompt generating unit 255 of the information processing apparatus 200A generates a prompt, which requests generation of an answer to the question, using the search result as an information source.

Specifically, when the prompt generating unit 255 receives the input of the specified item indicating the classification of the in-company information at S4002, the prompt generation unit 102 sets the chunk data acquired as a search result of the in-company information classified by the specified item being input, as the in-company information to be included in the prompt for requesting generation of the answer to the question.

When the question data is input at S4013, the prompt generating unit 255 sets the chunk data acquired as a search result of the in-company information classified by the specified item specified by the question analyzing unit 262, as the in-company information to be included in the prompt for requesting generation of the answer to the question.

Since the processes from S4022 to S4028 of FIG. 40 are the same as the processes from S911 to S917 of FIG. 9, the description thereof is omitted.

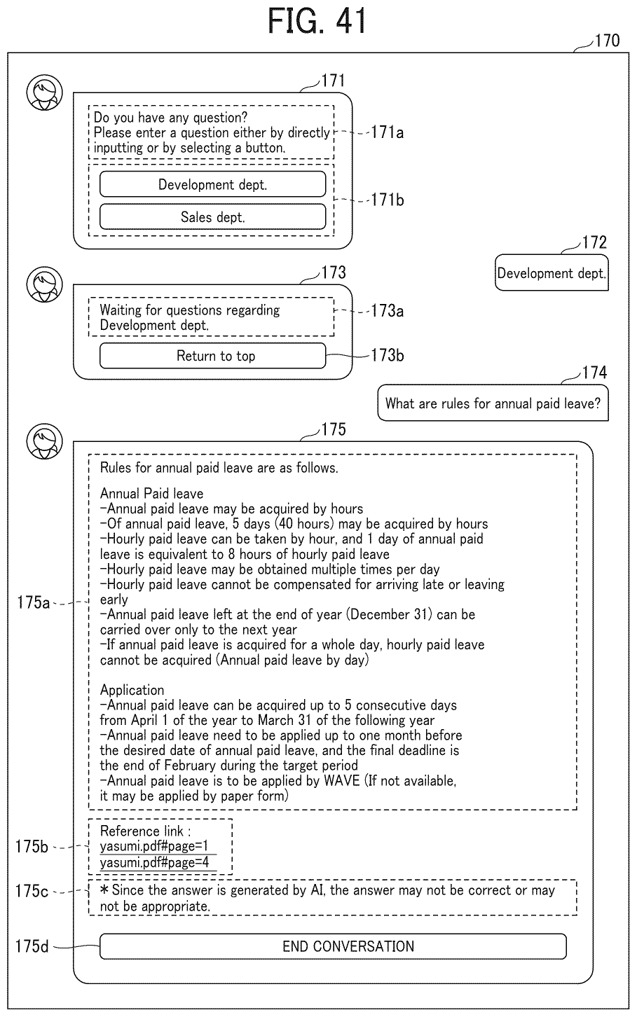

The chat screen is described below with reference to FIG. 41. FIG. 41 is a fourth diagram illustrating an example screen displayed by the terminal apparatus 600. FIG. 41 illustrates a screen 170, which is an example of the chat screen displayed on the terminal apparatus 600 at S4026 of FIG. 41. The screen 170 illustrated in FIG. 41 is also an example of the chat screen displayed at S4026 when a particular specified item is selected from the list of specified items at S4001 of FIG. 40.

The screen 170 includes display areas 171, 172, 173, 174, and 175. The display area 171 includes display areas 171a and 171b. The display area 171a displays a message prompting the user to select a specified item or input question data. The message being displayed may be previously set as a part of the operation information included in the scenario information.

The display area 171b displays operation buttons corresponding to the specified items in the list. In other words, the display area 171b displays a plurality of operation buttons as options for selecting the specified item.

The display area 172 displays the specified item selected in the display area 171. In the example of FIG. 41, the specified item “development department” is selected.

The display area 173 includes a display area 173a and an operation button 173b. The display area 173a displays a message transmitted to the terminal apparatus 600 at S4008 of FIG. 40. More specifically, the display area 173a displays a message indicating that the user is to answer a question about the specified item “development department”. The operation button 173b is an operation button for asking a question again from the beginning. When the operation button 173b is selected, the display area 172 and the subsequent areas may be hidden.

The display area 174 displays question data input by the user. The display area 175 includes display areas 175a, 175b, and 175c and an operation button 175d. The display area 175a displays the answer output from the large-scale language model 511. The display area 175b displays information indicating a storage destination of the in-company information that is a source of information.

The display area 175c displays a message indicating that answer data has been generated by the large-scale language model 511. The operation button 175d is an operation button for the user to end the conversation using the chat system 100A.

The display area 171 in the screen 170 of FIG. 41 may be displayed on the terminal apparatus 600, for example, when the user directly inputs the question data at S4001 of FIG. 40 and the specified item is not identified by the question analyzing unit 262 at S4014.

In this example, when the user directly inputs question data and the specified item is not identified by the question analyzing unit 262 at S4014, the information processing apparatus 200A may cause the terminal apparatus 600 to display a message asking the user about the user's attributes. For example, when the specified item is not identified by the question analyzing unit 262, the information processing apparatus 200A may display a message including a question for allowing the user to identify the specified item on the terminal apparatus 600.

Further, when the user directly inputs question data and when the specified item is not identified by the question analyzing unit 262 at S4014, the information processing apparatus 200A may cause the terminal apparatus 600 to display an inquiry to obtain an additional question from the user. In this case, the information processing apparatus 200A may generate a prompt for requesting generation of a question that requests the user of the terminal apparatus 600 to input additional information, output the prompt to the large-scale language model 511, and transmit the question output from the large-scale language model 511 to the terminal apparatus 600.

In this example, the in-company information is previously classified by each specified item and stored in the document DB 410A. By requesting the user of the terminal apparatus 600 to select the specified item, an answer to the question can be generated based on the in-company information, which is within a range desired by the user. This increases the probability that the answer with appropriate contents are output in response to the question of the user, thus increasing the accuracy of the answer to the question.

Further, in this example, the specified item indicating the classification of in-company information is identified based on the analysis result of the question data input at the terminal apparatus 600. The in-company information associated with the specified item that is identified is set as a search target to acquire an information source used for generating an answer. Accordingly, even when the user does not select the specified item, the answer to the question can be generated by using the in-company information within a range desired by the user as a search target, thus, increasing the accuracy of the answer to the question.

In the present disclosure, the in-company information is used as one example of the user-specific information, but the user-specific information is not limited to this example. For example, shop information specific to a shop may be used as the user-specific information.

Examples of the shop information include shop identification information such as a name, address, or telephone number of the shop, and purchase history information available to the shop.

Other examples of the user-specific information include personal identification information, account information, purchase history information, browsing history information, location information, preference information, and activity information.

The personal identification information includes information for identifying a particular person, such as a name, an address, a telephone number, or an electronic mail address. The account information includes information related to a particular online account, such as a user name, a password, and an account number. The purchase history information includes information such as a product or a service purchased by the user, a purchase date and time, and a payment method. The browsing history information includes information such as the pages browsed by the user on the website or the application, a search history, and a click history. The location information includes information related to a location such as a current location of the user or a past movement history. The preference information includes information indicating the preference or taste of the contents, and includes information on the contents, product, or service that the user may be interested in. The activity information is information related to the activity on the social media, and includes information such as posts shared by the user, a history of “likes” or comments, and a person that the user follows.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The illustrated server apparatuses are only illustrative of one of several computing environments for implementing the embodiments disclosed herein.

For example, in some embodiments, the information processing apparatus 200 includes a plurality of computing devices, e.g., a server cluster, that are configured to communicate with each other over any type of communications link, including a network, a shared memory, etc. to collectively perform the processes disclosed herein. Similarly, the server 500 and the information processing apparatus 200 or 200A can include a plurality of computing devices that are configured to communicate with each other.

Moreover, the information processing apparatus 200 or 200A can be configured to share the processing steps disclosed herein in various combinations. For example, the processes performed by the information processing apparatus 200 or 200A can be performed by the first storage device 300 or 300A or the second storage device 400 or 400A. Similarly, the functionality of the first storage device 300 or 300A or the second storage device 400 or 400A can be performed by the information processing apparatus 200 or 200A. Further, the illustrated elements of the information processing apparatus 200 or 200A, the first storage device 300 or 300A, and the second storage device 400 or 400A can be combined into a single server apparatus, or divided between a plurality of machines in combinations other than that illustrated for example in FIG. 8 or 31.

The information processing apparatus 200 may be any apparatus having a communication function. Other examples of the information processing apparatus 200 include, but not limited to, an output device such as a Projector (PJ), an Interactive White Board (a white board having an electronic whiteboard function capable of mutual communication (IWB)), and a digital signage, a Head Up Display (HUD) device, an industrial machine, an imaging device, a sound collecting device, a medical device, a network home appliance, an automobile (connected car), a notebook Personal Computer (PC), a mobile phone, a smartphone, a tablet terminal, a game console, a Personal Digital Assistant (PDA), a digital camera, a wearable PC or a desktop PC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The aspects of the present invention are as follows, for example.

According to Aspect 1, in an information processing apparatus, an input receiving unit receives an input of question data. In response to receiving the input of the question data, a prompt output unit outputs, to a large-scale language model, a prompt requesting generation of answer data to the question data based on user-specific information. An information output unit outputs, to a terminal apparatus, answer data that is output from the large-scale language model based on the prompt, as output answer data.

According to Aspect 2, the information processing apparatus according to Aspect 1 further includes a conversation history acquiring unit that acquires, from a first storage device, conversation history information on a conversation that has continued until immediately before the question data is input. The prompt output unit outputs, to the large-scale language model, a prompt including the conversation history information and requesting generation of a query, which searches a second storage device storing the user-specific information.

According to Aspect 3, the information processing apparatus according to Aspect 2 further includes an information acquiring unit that acquires the user-specific information, which is obtained as a result of searching the second storage device using the query that is output from the large-scale language model in response to the input of the prompt requesting generation of the query. The prompt output unit obtains the user-specific information acquired by the information acquiring unit, as the user-specific information to be included in the prompt requesting generation of the answer data.

According to Aspect 4, in the information processing apparatus according to Aspect 2, in a case where the conversation history information is not acquired by the conversation history acquiring unit, the prompt output unit obtains the user-specific information, which is a search result of the second storage device using the question data, as the user-specific information to be included in the prompt for requesting generation of the answer data.

According to Aspect 5, in the information processing apparatus according to any one of Aspect 1 to Aspect 4, the prompt output unit outputs, to the large-scale language model, a prompt including the output answer data output from the large-scale language model and requesting revision of the output answer data.

According to Aspect 6, the information processing apparatus according to any one of Aspect 1 to Aspect 5 includes an information acquiring unit that receives an input of priority information associated with the user-specific information unique and stores the user-specific information in a storage device in association with the priority information. In a case where the priority information is associated with the user-specific information, the prompt output unit outputs, to the large-scale language model, a prompt including the priority information and requesting generation of the answer data in which the priority information is prioritized.

According to Aspect 7, the information processing apparatus of any one of Aspect 1 to Aspect 6 further includes a search request unit that transmits a search request based on the question data to a first storage device storing question and answer information that associates registered question data and registered answer data. In a case where the registered answer data associated with the question data is not stored in the first storage device, the prompt output unit outputs a prompt for requesting generation of the answer data to the large-scale language model.

According to Aspect 8, in the information processing apparatus of Aspect 7, in a case where the registered answer data associated with the question data is stored in the first storage device, and an instruction to generate answer data by the large-scale language model is received, the prompt output unit outputs the prompt requesting generation of the answer data to the large-scale language model.

According to Aspect 9, in the information processing apparatus according to any one of Aspect 1 to Aspect 8, the prompt output unit outputs a prompt for requesting generation of the answer data to the large-scale language model, based on the user-specific information and information that the large-scale language model has learned.

According to Aspect 10, in the information processing apparatus according to any one of Aspect 1 to Aspect 8, the prompt output unit outputs a prompt for requesting generation of the answer data based on the information that the large-scale language model has learned to the large-scale language model, when the answer data associated with the question data is not included in the user-specific information.

According to Aspect 11, the information processing apparatus according to any one of Aspect 1 to Aspect 10 further includes a prompt generation unit that generates the prompt for requesting generation of answer data to the question data in response to receiving the input of the question data.

According to Aspect 12, in the information processing apparatus of Aspect 1, the user-specific information is stored in a second storage device while being classified by each specified item. The input receiving unit receives an input of an item indicating a classification of the user-specific information. The prompt output unit obtains a search result by searching for the user-specific information classified by the item using the question data, as the user-specific information unique to be included in the prompt for requesting generation of the answer data.

According to Aspect 13, in the information processing apparatus according to Aspect 1, the user-specific information is stored in a second storage device while being classified by each specified item. The information processing apparatus includes a question analyzing unit that identifies the item corresponding to the question data based on a result of analyzing the question data. The prompt output unit obtains a search result by searching for the user-specific information classified by the item identified by the question analyzing unit using the question data, as the user-specific information to be included in the prompt for requesting generation of the answer data.

According to Aspect 14, an information processing system includes an information processing apparatus, and a terminal apparatus that communicates with the information processing apparatus. The information processing apparatus includes an input receiving unit that receives an input of question data from the terminal apparatus, a prompt output unit, and an information output unit. In response to receiving the input of the question data, the prompt output unit outputs, to a large-scale language model, a prompt for requesting generation of answer data to the question data based on user-specific information. The information output unit outputs answer data output from the large-scale language model based on the prompt output from the prompt output unit, to the terminal apparatus as output answer data. The terminal apparatus includes a display control unit that displays the question data and the output answer data in association with each other.

According to Aspect 15, an information processing method is performed by an information processing system including an information processing apparatus and a terminal apparatus that communicates with the information processing apparatus. The information processing apparatus performs receiving an input of question data from the terminal apparatus; outputting a prompt, to a large-scale language model, the prompt requesting generation of answer data to the question data based on user-specific information; and outputting answer data output from the large-scale language model based on the prompt being output to the terminal apparatus as output answer data. The terminal apparatus performs displaying the question data and the output answer data in association with each other.

According to Aspect 16, a program causes the information processing apparatus to perform the information processing method.

1. An information processing apparatus comprising
circuitry configured to:
receive an input of question data;
in response to receiving the input of the question data, output, to a large-scale language model, a prompt requesting generation of answer data to the question data based on user-specific information; and
output, to a terminal apparatus, output answer data that is output from the large-scale language model in response to an input of the prompt.

2. The information processing apparatus according to claim 1, wherein
in a case where the circuitry acquires, from a first memory, conversation history information on a conversation that has continued until a time when the question data is input,
the circuitry is configured to output a prompt including the conversation history information that is acquired and requesting generation of a query for searching a second memory storing the user-specific information.

3. The information processing apparatus according to claim 2, wherein the circuitry is further configured to
acquire the user-specific information being a search result of searching the second memory using the query that is output from the large-scale language model in response to the input of the prompt, as the user-specific information to be included in the prompt requesting generation of answer data.

4. The information processing apparatus according to claim 2, wherein
in a case where the circuitry does not acquire the conversation history information,
the circuitry is configured to acquire the user-specific information being a search result of the second memory using the question data, as the user-specific information to be included in the prompt requesting generation of answer data.

5. The information processing apparatus according to claim 1, wherein the circuitry is further configured to
output, to the large-scale language model, another prompt including the output answer data and requesting revision of the output answer data.

6. The information processing apparatus according to claim 1,
wherein the circuitry is further configured to, in response to receiving an input of priority information associated with the user-specific information, store the priority information and the user-specific information in association in a memory, and
the circuitry is configured to output the prompt including the priority information associated with the user-specific information and requesting generation of answer data based on the priority information.

7. The information processing apparatus according to claim 1,
wherein the circuitry is configured to transmit a search request based on the question data to a first memory storing question and answer information associating registered question data and registered answer data, and
in a case where the question and answer information does not include registered answer data associated with the question data, the circuitry is configured to output the prompt requesting generation of answer data to the large-scale language model.

8. The information processing apparatus according to claim 1,
wherein the circuitry is configured to transmit a search request based on the question data to a first memory storing question and answer information associating registered question data and registered answer data, and
in a case where the question and answer information includes registered answer data associated with the question data, the circuitry is configured to output the prompt requesting generation of answer data to the large-scale language model, in response to a request for generation of answer data using the large-scale language model.

9. The information processing apparatus according to claim 1, wherein the circuitry is configured to
output, to the large-scale language model, the prompt requesting generation of answer data based on the user-specific information and information that the large-scale language model has learned.

10. The information processing apparatus according to claim 1, wherein
in a case where the user-specific information does not include answer data associated with the question data, the circuitry is configured to output, to the large-scale language model, the prompt requesting generation of answer data based on the information that the large-scale language model has learned.

11. The information processing apparatus according to claim 1, wherein
in response to receiving the input of the question data, the circuitry is configured to generate the prompt requesting generation of answer data to the question data.

12. The information processing apparatus according to claim 1, wherein
the user-specific information are classified by a plurality of specified items and stored in a second memory, and
in response to receiving an input of a particular specified item of the plurality of specified items, the circuitry is configured search the user-specific information stored for the particular specified item using the question data to obtain the user-specific information to be included in the prompt.

13. The information processing apparatus according to claim 1, wherein
the user-specific information are classified by a plurality of specified items and stored in a second memory,
the circuitry is configured to identify a particular specified item of the plurality of specified item that corresponds to the question data, based on an analysis result of the question data, and
search the user-specific information stored for the particular specified item using the question data to obtain the user-specific information to be included in the prompt.

14. An information processing system comprising:
the information processing apparatus according to claim 1; and
the terminal apparatus configured to communicate with the information processing apparatus, the terminal apparatus including:
a display to display the question data and the output answer data in association.

15. An information processing method comprising:
receiving an input of question data;
in response to receiving the input of the question data, outputting, to a large-scale language model, a prompt requesting generation of answer data to the question data based on user-specific information;
outputting answer data that is output from the large-scale language model in response to an input of the prompt, the question data and the output answer data being displayed in association.

16. A non-transitory recording medium which, when executed by one or more processors, causes the processors to perform an information processing method comprising:
receiving an input of question data;
in response to receiving the input of the question data, outputting, to a large-scale language model, a prompt requesting generation of answer data to the question data based on user-specific information; and
outputting, to a terminal apparatus, output answer data that is output from the large-scale language model in response to an input of the prompt.
